(19) United States
(12) Patent Application Publication
(10) Pub. No.: US 2024/0404531 A1
(43) Pub. Date: Dec. 5, 2024

(54) Method and System for Coding Audio Data

(71) Applicant: Apple Inc., Cupertino, CA (US)

(72) Inventors: Moo Young Kim, San Diego, CA (US); Sina Zamani, Cupertino, CA (US); Dipanjan Sen, Dublin, CA (US); Tejaswi Nanjundaswamy, San Jose, CA (US)

(21) Appl. No.: 18/662,842

(22) Filed: May 13, 2024

Related U.S. Application Data
(60) Provisional application No. 63/506,069, filed on Jun. 3, 2023.

(51) Int. Cl. G10L 19/008; H04S 7/00

(52) U.S. Cl. CPC G10L 19/008; H04S 7/308; H04S 2400/11; H04S 2420/11

(57) ABSTRACT

A method that includes a decoder-side method that includes receiving a bitstream that includes an encoded representation of an input audio signal and metadata associated with the input audio signal, producing a decoded representation of the input audio signal by decoding the encoded representation using a Matching Pursuit (MP) coding-based algorithm, producing audio driver signals by rendering the input audio signal based on the metadata, and driving speakers using the audio driver signals.

### RELATED APPLICATIONS

This application claims the benefit of priority of U.S. Provisional Application No. 63/506,069, filed Jun. 3, 2023, which is herein incorporated by reference.

### FIELD

An aspect of the disclosure relates to an audio processing system that encodes different types of audio data into higher-order ambisonics (HOA) data for bitrate reduction. Other aspects are also described.

### BACKGROUND

A higher-order ambisonics (HOA) signal may include a three-dimensional (3D) representation of a sound field. In particular, the sound field may be represented by a summation of weighted, spherical harmonic basis functions of increasing order 0, 1, 2, . . . . As the set of basis functions is extended to include higher order elements (order two and higher), the representation of the sound field becomes more detailed, e.g., having higher acoustic resolution. The weights that are applied to the basis functions are referred to as spherical harmonic coefficients.

### SUMMARY

According to an aspect of the disclosure is a decoder-side method that includes receiving a bitstream that includes an encoded representation of an input audio signal and metadata associated with the input audio signal; producing a decoded representation of the input audio signal by decoding the encoded representation using a Matching Pursuit (MP) coding-based algorithm; producing a group of audio driver signals by rendering the input audio signal based on the metadata; and driving a group of speakers using the group of audio driver signals.

In one aspect, the decoded representation includes a higher-order ambisonics (HOA) representation of the input audio signal, where the method further includes applying a conversion matrix to the HOA representation to reconstruct the input audio signal. In another aspect, the input audio signal includes a group of full-range audio channels of a surround-sound format, where the method further includes receiving at least one band-limited audio channel associated with the surround-sound format, where producing the group of audio driver signals includes assigning each of the channels to a particular speaker of the group of speakers based on the metadata.

In one aspect, the input audio signal includes a set of one or more audio objects and the metadata includes positional information relating to the set of one or more audio objects, where the group of audio driver signals are produced by spatially rendering the set of one or more audio objects according to the positional information. In another aspect, the method further includes: determining a number of the set of one or more audio objects; and determining the conversion matrix based on the number. In another aspect, the method further includes receiving an output speaker layout for the group of speakers, wherein the set of one or more audio objects are spatially rendered according to the output speaker layout.

In another aspect, the bitstream is received from an encoder-side device, where the conversion matrix is an inverse matrix of a matrix used by the encoder-side device to produce the encoded representation of the input audio signal.

In one aspect, the decoded representation of the input audio signal includes a mixed signal, where the method further includes, splitting the mixed signal into: a group of surround-sound channels of a surround-sound format, one or more audio objects that include one or more audio signals, and HOA data that includes a plurality of HOA signals. In another aspect, producing the group of audio driver signals includes: rendering the group of surround-sound channels, the one or more audio signals, and the group of HOA signals according to the metadata and an output speaker layout of the group of speakers; and mixing the renderings into the group of audio driver signals.

According to another aspect of the disclosure is an encoder-side method that includes: receiving an input audio signal of a piece of audio content and metadata relating to the input audio signal; encoding, using the MP coding-based algorithm, the input audio signal; and transmitting the encoded input audio signal and the metadata to an audio playback device.

In one aspect, the input audio signal includes a group of surround-sound audio channels that includes a sound source, where the group of surround-sound audio channels includes a first set of one or more full-range audio channels and a second set of one or more band-limited audio channels, where the method further includes converting the first set into a HOA representation of the sound source, where encoding includes encoding, using the MP coding-based algorithm, the HOA representation into a bitstream for transmission to the audio playback device. In another aspect, the method further includes encoding the second set into the bitstream separately from the encoded HOA representation. In another aspect, the metadata includes surround-sound speaker layout information for the group of surround-sound audio channels, where the first set is converted into HOA representation according to the surround-sound speaker layout information.

In one aspect, receiving an input audio signal includes receiving a set of one or more audio objects, each audio object having at least one audio signal, where the method further includes producing a HOA representation of the set of one or more audio objects, where encoding includes encoding, using the MP coding-based algorithm, the HOA representation into a bitstream for transmission to the audio playback device. In another aspect, the method further includes determining a number of the set of one or more audio objects; and determining a conversion matrix based on the number, where the HOA representation is produced by applying the conversion matrix to the set of one or more audio objects.

In one aspect, the input audio signal includes: a group of surround-sound audio channels of the piece of audio content, a HOA representation of the piece of audio content and a set of one or more audio objects of the piece of audio content, where the method further includes producing a mixed audio signal that includes the group of surround-sound audio channels, the HOA representation, and the set of one or more audio objects, where encoding includes encoding, using the MP coding-based algorithm, the mixed audio signal into a bitstream for transmission to the audio playback device.

The above summary does not include an exhaustive list of all aspects of the disclosure. It is contemplated that the disclosure includes all systems and methods that can be practiced from all suitable combinations of the various aspects summarized above, as well as those disclosed in the Detailed Description below and particularly pointed out in the claims. Such combinations may have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect of this disclosure are not necessarily to the same aspect, and they mean at least one. Also, in the interest of conciseness and reducing the total number of figures, a given figure may be used to illustrate the features of more than one aspect, and not all elements in the figure may be required for a given aspect.

FIG. 1 shows a block diagram of a system for coding audio content for rendering through one or more speakers according to one aspect.

FIG. 2 shows a block diagram of a system for encoding and decoding multi-channel audio that includes converting surround-sound audio channels into a higher-order ambisonics (HOA) format according to one aspect.

FIG. 3 shows a block diagram of a system for encoding and decoding multi-channel audio using a conversion matrix codebook for converting the audio into a HOA format according to one aspect.

FIG. 4 shows a block diagram of a system for encoding and decoding multi-channel audio using an identity matrix based on the number of surround-sound audio channels of the channel audio according to one aspect.

FIG. 5 shows a block diagram of a system for encoding and decoding multi-channel audio according to one aspect.

FIG. 6 shows a block diagram of a system for encoding and decoding audio objects using a conversion matrix codebook for assigning the audio objects into speaker locations for conversion into a HOA format according to one aspect.

FIG. 7 shows a block diagram of a system for encoding and decoding audio objects using a conversion matrix codebook for assigning the audio objects into speaker locations for conversion into a HOA format according to another aspect.

FIG. 8 shows a block diagram of a system for encoding and decoding audio objects using a conversion matrix codebook according to another aspect.

FIG. 9 shows a block diagram of a system for encoding and decoding audio objects using an identity matrix according to one aspect.

FIG. 10 shows a block diagram of a system for encoding and decoding audio objects according to one aspect.

FIG. 11 shows a block diagram of a system for encoding and decoding mixed audio according to one aspect.

FIG. 12 illustrates an example of system hardware.

### DETAILED DESCRIPTION

Several aspects of the disclosure with reference to the appended drawings are now explained. Whenever the shapes, relative positions and other aspects of the parts described in a given aspect are not explicitly defined, the scope of the disclosure here is not limited only to the parts shown, which are meant merely for the purpose of illustration. Also, while numerous details are set forth, it is understood that some aspects may be practiced without these details. In other instances, well-known circuits, structures, and techniques have not been shown in detail so as not to obscure the understanding of this description. Furthermore, unless the meaning is clearly to the contrary, all ranges set forth herein are deemed to be inclusive of each range's endpoints.

Traditionally, audio content is produced, distributed, and consumed using a two-channel stereo format. Other audio formats, such as multi-channel audio, object-based audio, and/or ambisonics aim to provide a more immersive listener experience. Delivery of immersive audio content, however, may be associated with a need for larger bandwidth, such as requiring an increased data rate for streaming and downloading as compared to that of two-channel stereo format. If bandwidth is limited, however, techniques are desired to reduce the audio data size while maintaining the best possible audio quality. Therefore, there is a need to deliver a richer and more immersive audio content using limited bandwidth.

To overcome these deficiencies, the present disclosure provides an audio processing system for encoding and decoding audio content using a Matching Pursuit (MP) coding algorithm which may allow for bitrate reduction based on changes to the overall bandwidth of the system while maintaining a high quality of the audio content. For example, an encoder-side device may receive an input audio signal of a piece of audio content and metadata relating to the input audio signal. For example, the input audio signal may include multi-channel audio content in a surround sound format, such as 5.1 and/or may include one or more audio objects. The system may encode either (or both) of these types of audio content using MP. For instance, the system may convert the audio content into a higher-order ambisonics (HOA) representation, where the sound sources of the input audio signal may be converted into a three-dimensional (3D) sound field, and may encode the HOA representation. The system may transmit the encoded input audio signal, along with the received metadata associated with the content, as an encoded bitstream to an audio playback device or decoder-side device for decoding and rendering for playback. As a result, the present disclosure efficiently encodes and transmits the audio content, along with associated metadata to the audio playback device, whereby the decoder-side device may use the metadata for rendering the audio content.

As referenced herein, “audio content” (or audio data) may be (and include) any type of audio, such as a musical composition, a podcast, audio of a virtual reality (VR) environment, a sound track of a motion picture, etc. In one aspect, the audio content may be a part of a piece of audio content, which may be an audio program or audio file that includes one or more audio signals that includes at least a portion of the audio content. In some aspects, the audio program may be any type of audio content format. In one aspect, an audio program may include audio content for spatial rendering as one or more data files in one or various 3D audio formats, such as having one or more audio channels. For instance, an audio program may include a mono audio channel or may be a multi-audio channel format (e.g., two stereo channels, six surround source channels (in 5.1 surround format), etc.). In another aspect, the audio program may include one or more audio objects, each having at least one audio signal, and metadata that may include positional data (for spatially rendering the object's audio signals) in 3D sound. In another aspect, the audio program may be represented in a spherical audio format, such as HOA audio format.

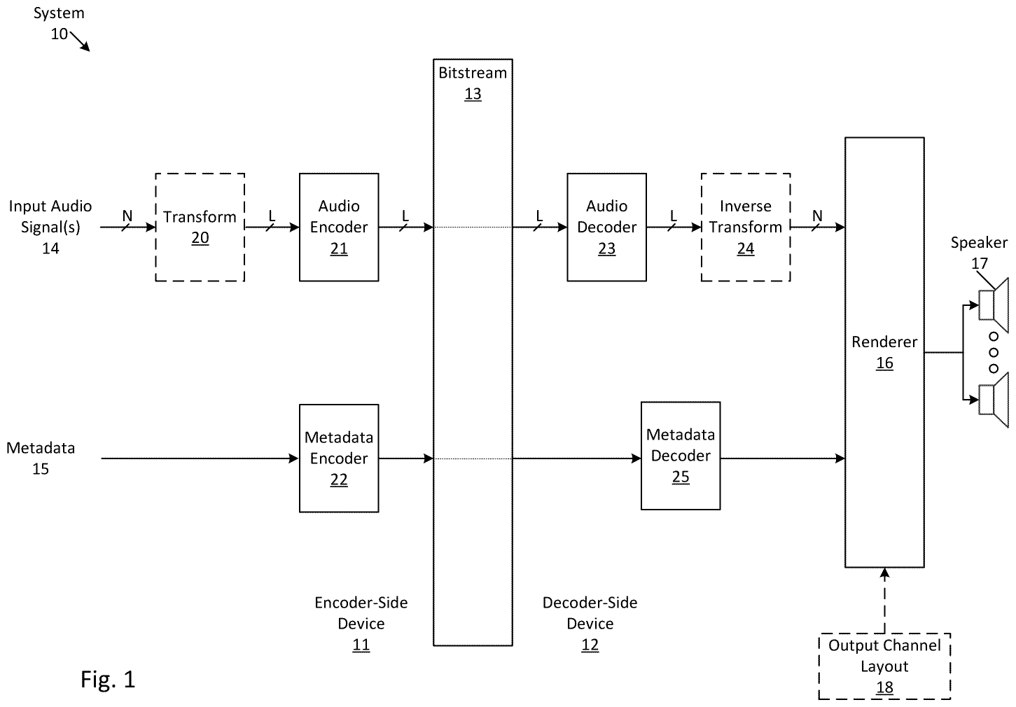

FIG. 1 shows a block diagram of an audio processing system (or system) 10 for coding audio content for rendering through one or more speakers 17 according to one aspect. The system 10 includes an encoder-side device 11 and a decoder-side device 12. In one aspect, each of the devices may be any electronic device that may include electronic components (e.g., one or more processors, memory, etc.), and may be capable of performing (e.g., through the use of one or more electronic components) one or more computational operations for encoding/decoding audio content, transmitting/receiving encoded bitstream(s), and (spatially) rendering audio content (e.g., through one or more speakers). For example, either of the devices may be a desktop computer, a laptop computer, a digital media player, etc. In one aspect, a device may be a portable electronic device (e.g., being handheld operable), such as a tablet computer, a smart phone, etc. In another aspect, the source device may be a wearable device (e.g., a device that is designed to be worn on (e.g., attached to clothing and/or a body of) a user, such as a smart watch. In another aspect, one of the devices may be a (e.g., remote) electronic server. For example, the encoder-side device 11 may be a stand-alone electronics server, a computer (e.g., desktop computer), or a cluster of server computers that are configured to store, encode, stream (transmit), and/or receive digital audio content, such as audio content (e.g., as one or more audio signals in any audio format). In which case, the encoder-side device 11 may transmit encoded audio content to the decoder-side device 12, which may be an audio playback device, such as a smartphone that may be capable of decoding the audio content for playback through one or more speakers.

As shown, the decoder-side device 12 includes one or more speakers 17 for outputting or playing back audio content. In one aspect, the speaker(s) may be electrodynamic drivers that may be specifically designed for sound output at certain frequency bands, such as a woofer, tweeter, or midrange driver, for example. In one aspect, the speaker(s) may be “full-range” (or “full-band”) electrodynamic drivers that each reproduces as much of an audible frequency range as possible. In one aspect, the speakers may be integrated within (e.g., a housing of) the decoder-side device. In another aspect, the speakers may be a part of a separate electronic device that may be communicatively coupled with the decoder-side device. In some aspects, the speakers may be loudspeakers or may be a part of headphones (e.g., with two speakers). In another, the device 12 may be part of a playback system having the speakers (e.g., loudspeakers). In another aspect, the speakers may be a part of an electronic device that may be configured to render audio of a virtual (augmented or mixed) reality environment.

Examples may include a stand-alone speaker, a smart speaker, a home theater system, or an infotainment system that is integrated within a vehicle. In another aspect, the decoder device may be a head-worn device having the speakers 17 arranged output sound into the ambient environment. For instance, when the device is a pair of smart glasses, the device may include “extra-aural” speakers that are arranged to project sound into the ambient environment (e.g., in a direction that is away from at least a portion, such as cars or ear canals, of a wearer), which are in contrast to “internal” speakers of a pair of headphones that are arranged to project sound into (or towards) a user's ear canal when worn.

The encoder-side device 11 may include several operational blocks, such as a transform 20 (which may be optional), an audio encoder 21, and a metadata encoder 22. The decoder-side device 12 may include several blocks, such as an audio decoder 23, an inverse transform 24 (which may be optional), a metadata decoder 25, a (spatial audio) renderer 16, and an optional output channel layout 18. In one aspect, each of these blocks represent one or more operations which may be performed by each respective device. In particular, the operations may be performed by one or more processors (or controllers) integrated into (or coupled to) each device. As an example, one or more processors of the encoder-side device may be configured to perform operations of blocks 20-22. In one aspect, blocks may be merged (or combined). For example, the encoder-side device may include one encoder that may be configured to encode audio data and metadata. In another aspect, either device may perform operations of the other device. For example, the encoder-side device 11 may perform one or more decoder-side operations when receiving encoded data, as described herein.

The encoder-side device 11 may be configured to receive one or more input audio signals 14, N signals (or channels), of (or be associated with) a piece of audio content and metadata 15 that relates to the received input audio signal. In one aspect, the input audio signal may be any type of audio content in any type of audio format. For example, the input audio signal may include one or more surround-sound audio channels (in a surround-sound format, such as 5.1, 7.1.4, etc.). In which case, the input signal may include one or more full-range audio channels and one or more band limited audio channels. For example, in the case of 5.1 surround sound audio content, the input signal may include five full-range audio channels (front left, front right, a center channel, and two surround channels), and a low-frequency effects (LFE) channel. In another aspect, the input audio signal 14 may include one or more audio objects, where each audio object includes (or is associated with) one or more audio signals that include sound of one or more sound sources and metadata relating to the sound source(s). In particular, the input audio signal 14 may include the one or more audio signals of each audio object. In addition, the input audio signal 14 may include an angular/parametric representation of a virtual sound source (or sound field), such as a HOA representation of a sound space that includes the sound source (e.g., positioned at a virtual position within the space). In particular, the input audio signal may include HOA data (or signals)

The received metadata 15 may be associated with the received input audio signal 14, and may include information relating to the signals. For example, in the case of multi-channel audio content, the metadata may include input audio channel layout information relating to the content, whereby the layout information may indicate speaker locations of the audio channels and may indicate a number (and type) of channels. For example, for 5.1 surround sound audio, the metadata may include surround-sound speaker layout information that indicates that the input audio signal includes (and/or indicates which channels of the input audio signal are) five full-range audio channels and one LFE channel and/or which of the channels are to be positioned at particular surround-sound locations (e.g., indicating that one channel is for a left surround speaker). In the case of audio objects, the metadata may include positional (or spatialization) information (e.g., position and/or orientation) of one or more sound sources associated with an audio object with respect to a reference point (e.g., a listener position). In another aspect, the metadata may include any information (e.g., necessary) for rendering the audio content of the input audio signals. As another example, the metadata may include other information, such as one or more gains, one or more equalization (EQ) operations, may indicate the number of channels (signals) associated with audio content, etc.

In one aspect, the metadata 15 may be received as a part of (or contained within) at least one of the input audio signals 14. In another aspect, the metadata may be received separate from the input audio signals. For example, the input audio signals may be retrieved from memory of the encoder-side device 11, while at least a portion of the metadata 15 may be retrieved from a remote electronic device, for example, an electronic server.

The transform 20 may be configured to receive the N input audio signals 14 and apply one or more operations to transform or convert the N signals into L signals. For example, the transform may apply one or more conversion matrices upon one or more received signals 14 to convert the signals into L signals, which may have more than, less than, or the same number of signals as the received signals. In particular, the transform 20 may apply a conversion matrix (e.g., which may be stored within memory of the encoder-side device and/or may be generated by the device) to convert the received input audio signals from one audio format to another audio format, such as converting the input audio signal into a HOA representation (having one or more HOA signals as HOA data) of the input audio signal. For example, in the case of audio objects, the transform 20 may apply a conversion matrix to one or more (e.g., audio signals of the) audio objects to produce a matrix (e.g., putting the audio objects in the channel domain), and then converting the matrix into a HOA representation of the audio objects. As another example, when the input audio signal includes several surround-sound audio channels that includes one or more sound sources, the transform 20 may convert at least some of the surround-sound channels into an HOA representation. In particular, the transform 20 may apply a conversion matrix to full-range audio channels of the surround-sound channels to convert the channels into HOA format, while leaving the LFE channels to be encoded and transmitted separately. More about conversion matrices is described herein.

The audio encoder 21 may be configured to receive the (e.g., transformed) input audio signals, and produce an encoded audio signal, having L number of audio signals (or channels), by performing one or more encoding operations. In particular, the audio encoder may be configured to encode audio data (e.g., having one or more audio signals) into an encoded bitstream 13 for transmission to one or more decoder-side devices 12. Specifically, the audio data may be encoded into the bitstream, which may be transmitted (e.g., via a computer network) to one or more devices. In another aspect, the bitstream may be transmitted wirelessly. For instance, the encoder-side device may be configured to establish a wireless connection with the decoder-side device via a wireless communication protocol (e.g., BLUETOOTH protocol or any other wireless communication protocol). During the established wireless connection, the device 11 may exchange (e.g., transmit and receive) data packets (e.g., Internet Protocol (IP) packets) with the device 12, which may include encoded audio digital data (e.g., in any audio format).

In one aspect, the encoded data may be transmitted in “real-time,” meaning as the data is encoded it may be subsequently (e.g., with a minimal amount of time) transmitted. In addition, the audio content may be encoded and transmitted while the audio content is being streamed to the decoder-side device for playback. This may be the case when audio content is a live broadcast. In another aspect, the encoded data may be stored in memory of the encoder-side device, and transmitted as the bitstream 13 at a later time.

In one aspect, the audio encoder 21 may encode the input audio signal 14 using a Matching Pursuit (MP) coding-based algorithm. MP is a sparse approximation algorithm, which computes a (e.g., nonlinear) approximation of a signal by building a sequence of sparse approximations, or salient components, to the signal. In one aspect, the algorithm may be a principal components analysis, PCA, or any linear transform, in which one or more spatial descriptors (“SDs”) are produced from the input signal. In particular, the input signal may be an input (“H”) matrix of a HOA representation, where the SDs describe spatial aspects, salient audio components, such as direction of arrival and diffuseness associated with the H matrix. The PCA or linear transform may be performed directly upon a zero mean covariance matrix. In one aspect, the zero mean covariance matrix may be computed for the result of a column-wise mean vector subtraction from the input H matrix. In one aspect, the column-wise mean vector subtracted H matrix may be referred to here as the H˜ matrix. A salient component (SC) extraction process may then performed using the SD and the H˜ matrix (e.g., whereby PCA may be applied to the H˜ matrix), which produces “P” salient audio components, which may (e.g., the SCs and/or SDs) then be quantized and transmitted as (e.g., an encoded) bitstream to one or more decoder-side devices. In one aspect, the column-wise mean vector may be transmitted (via the bitstream) to the decoder-side to be made available by a decoding process (e.g., by adding the mean vector to a product of recovered P salient audio components and recovered spatial descriptors) to generate (reconstruct) recovered (synthesized) H′ matrix at the decoder side.

In another aspect, the algorithm may be modified so that the column-wise mean vector need not be transmitted to the decoder-side device, which may advantageously reduce the required bandwidth. In particular, the salient component extraction may be modified at the encoder-side device to use the input audio signal (e.g., H matrix) directly, instead of using the column wise mean subtracted H˜ matrix, when extracting the salient components. Using this approach, the synthesis (performed in the decoding side) computes an accurate H′ matrix despite not having access to the column wise mean vector. In another aspect, the audio encoder may use any type of PCA coding algorithm to encode (and decode) audio data. In another aspect, the encoder-side device may use any type of audio codec to encode (and decode) the audio data for transmission.

The metadata encoder 22 may be configured to receive the metadata 15, which may be extracted from the input audio signal 14 or may be received separately from the signal 14, and may be configured to encode the metadata 15 into the (audio) bitstream 13. For example, the encoder may encode the metadata into any type of encoding format, such as in Extensible Markup Language (XML). As described herein, the encoder-side device 11 may encode both the input audio signal(s) 14 and the metadata 15 into the (same) bitstream 13. In another aspect, the device 11 may encode either in separate bitstreams, e.g., the encoded audio signals into the bitstream 13 that may be transmitted to the decoder-side device 12, and the encoded metadata in a different bitstream for transmission to the device 12. In another aspect, the encoded metadata may be transmitted at a different time than the transmission of the encoded audio content.

As described thus far, the input audio signal(s) 14 may include audio content of a particular format, such as surround-sound format, audio object format, or HOA format. In another aspect, the input audio signal 14 may include one or more audio formats. For example, the encoder-side device 11 may include different types of audio content in different format, such as a movie soundtrack in a surround-sound 5.1 format, VR environment audio content in a HOA format, and a musical composition in an audio format with one more audio objects. As another example, the input audio signal may include (at least portions) of a piece of audio content in the different audio formats. For example, the input audio signals 14 may include several surround-sound audio channels of a piece of audio content (e.g., the movie soundtrack), a HOA representation of a sound field that includes at least one sound source of the piece of audio content as several HOA signals, and one or more audio objects that includes at least one audio signal that includes sound of the sound source.

The encoder-side device 11 may be configured to produce one or more mixed audio signals that include all (or at least some) of the audio data of the input audio signals 14. In particular, the mixed signals may include the surround-sound audio channels, the HOA signals, and the audio signals of the audio objects. The audio encoder 21 may encode the mixed signal, using the MP coding-based algorithm, as described herein, into the bitstream 13 for transmission to the decoder-side device 12. In addition, the metadata 15 that is encoded and transmitted may include information for the mixed audio content, such as having a speaker layout information of the surround-sound format, positional information of the audio object, and any other information relating to the mixed audio data. As a result, the encoder-side device may be capable of efficiently encoding and transmitting multiple types of audio content for playback by another (or one or more) playback devices.

Turning to the decoder-side device 12, the device 12 may be configured to receive the bitstream 13 and render audio data from the bitstream to one or more speakers 17. In particular, based on the received bitstream 13, N channels of the input audio signal 14 and metadata 15 may be decoded, where an optional inverse transform 24 may be applied to L decoded channels to convert them to the N channels that may be provided to the renderer 16. In one aspect, the decoded data may be provided to the renderer followed by rendering of the audio data based on the metadata and/or (optional) output channel layout 18, which as described herein may indicate the layout of the speakers 17, e.g., whether they are in a surround-sound 7.1.4 layout or headphone layout.

In one aspect, the decoder-side device 12 may receive the bitstream 13 in real-time, meaning the decoder-side device 12 may receive the bitstream 13 as it is being received (retrieved), encoded, and/or transmitted by the encoder-side device 11 and accounting for minimal amount of time due to transmission of the data across one or more networks. In particular, the decoder-side device 12 may receive the bitstream that may include an encoded representation of the input audio signal 14 and encoded metadata 15 that may be associated with the input audio signal.

The audio decoder 23 may be configured to produce a decoded representation of the input audio signal by decoding the encoded representation using the MP coding-based algorithm, which may have been used to encode the representation by the audio encoder 21. In particular, the encoded representation may include the salient audio components and the spatial descriptors produced by the audio encoder 21, where the audio decoder may use these features to synthesize a recovered (or reconstruct) the input audio signal 14. For example, the decoded representation may be a HOA representation of a sound field associated with (or include) the input audio signal 14. In particular, the audio decoder 23 may produce H′ as a reconstruction of the input H matrix that was encoded by the audio encoder 21. In addition, the decoder may use the column-wise mean vector to generate the received matrix (e.g., by adding the mean vector to a product of the recovered salient audio components and the received spatial descriptors). The metadata decoder 25 may be configured to receive the encoded metadata (e.g., from the bitstream 13 or from a different bitstream), and produce (or reconstruct) the metadata 15 by decoding the encoded data.

The inverse transform 24 may be an optional block, which may be applied upon the decoded audio data if the encoder-side device had applied optional transform 20. In particular, the transform 24 may apply a conversion matrix to the decoded representation from the audio decoder 23 to reconstruct the input audio signal 14 for rendering by the renderer 16. For example, the transform 20 of the encoder-side device may have applied a conversion matrix to transform audio objects of the input audio signal 14 into HOA format. In which case, the inverse transform 24 may transform the decoded representation, which may be in the HOA format, back into the audio objects by applying an inverse matrix of the matrix that was originally applied by the transform 20. In one aspect, in the case in which the bitstream 13 includes audio objects, the metadata reconstructed by the decoder-side device may include positional information relating to the audio object, which may allow the renderer 16 to spatially render audio signals of the audio object.

As another example, when the decoded representation is HOA format that was constructed from several full-range audio channels of a surround-sound format by the transform 20, the inverse transform 24 may reconstruct the original full-range audio channels. As described herein, LFE channels may not be encoded along with the full-range channels. In which case, the decoder-side device 12 may receive at least one LFE channel associated with the surround-sound format, where the decoder-side device (e.g., renderer 16) may be configured to receive the full-range audio channels and the LFE channels and may be configured to produce audio driver signals by assigning each of the channels to a particular speaker 17 based on the metadata 15, which may include an input speaker layout associated with the surround-sound format.

As described herein, the transform 20 and inverse transform 24 may be optional. In which case, the audio encoder 21 may receive N input audio signals 14, produce the encoded bitstream 13 with the signals 14 for transmission by the encoder-side device 11 to the decoder-side device 12. The audio decoder 23 may decode the data to produce a reconstruction of the N signals 14 for the renderer. In one aspect, this may be the case when the input audio signals include one or more HOA signals in a HOA format, such as A-format, B-format, etc. In which case, the audio encoder 21 may encode the N HOA input audio signals 14 into the bitstream 13, where the audio decoder may decode the encoded bitstream to reconstruct the N HOA input audio signals 14, which may then be rendered by the renderer 16 according to the layout 18.

The renderer 16 may be configured to receive the reconstructed N input audio signals 14, and render the signals into one or more driver signals for driving one or more speakers 17. In particular, the renderer may be configured to produce driver signals by rendering the decoded representation of the input audio signal (e.g., the reconstruction of the signal) based on the decoded metadata 15 and/or based on (optional) output channel layout 18, which indicates a layout of the speakers 17. In particular, the layout may include a table (data structure) that indicates speaker positions of the speakers 17 (e.g., with respect to a listener position) within a listening environment. In another aspect, the speaker position may indicate positions of a multi-channel layout. For example, the layout 18 may indicate which speaker is a front left speaker and which speaker is a front right speaker of a surround-sound layout. In one aspect, the layout 18 may be received from local memory, or may be retrieved from a remote storage device.

In some aspects, the renderer 16 may perform spatial audio rendering operations in order to spatially render one or more audio signals. For example, the renderer may apply spatial filters, such as head-related transfer functions (HRTFs), which may be personalized for the user of the system 10 in order to account for the user's anthropometrics. In another aspect, the spatial filters may be default (or generic) filters. As a result, the renderer is configured to produce spatial audio signals (e.g., binaural audio signals), which when outputted through speakers 17 (e.g., of headphones) produces a 3D sound (e.g., giving the user the perception that sounds are being emitted from a particular location within an acoustic space).

As described herein, the encoder-side device 11 may produce encoded mixed audio signals that may include a mix of one or more audio formats. For example, the bitstream may include an encoded mixed signal that includes several surround-sound signals of a surround-sound format, one or more audio objects that include one or more audio signals, and HOA data that includes several HOA signals, where each different format may include similar or different audio content (e.g., the surround-sound signals having a soundtrack of a motion picture, while the HOA data may include a musical composition). In which case, the decoder-side device may be configured to split these respective signals, where the renderer 16 may spatially render the split signals according to the metadata 15 and/or the output channel layout 18 to produce the driver signals. As a result, the decoder-side device may playback several different types of audio content through the speakers. In another aspect, the decoder-side device 12 may store some audio formats in memory (for later playback), and may playback only one of the audio formats, such as the surround-sound format through the speakers 17.

In one aspect, the system 10 may be configured to perform the audio coding operations described herein in real-time, such that the encoder-side device 11 may perform audio processing operations upon the input audio signals 14 and the metadata to encode the data and to transmit the data via the bitstream 13 to the decoder-side device 12, which may then decode the information for rendering through speakers 17, where these operations may be performed within a minimal amount of time (e.g., accounting for processing time for operations performed by both devices and transmission time for transmitting the data within the bitstream 13).

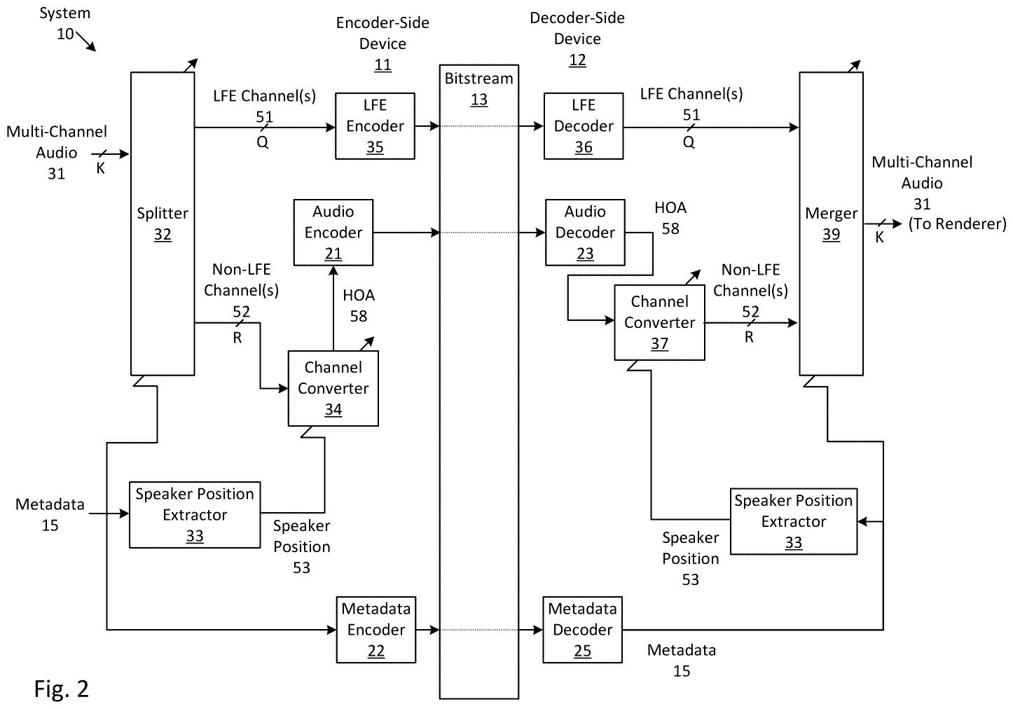

FIGS. 2-5 include several aspects of encoding and decoding multi-channel audio. In particular, FIG. 2 shows a block diagram of the system 10 for encoding and decoding multi-channel audio that includes converting surround-sound audio channels into a higher-order ambisonics (HOA) format according to one aspect. In particular, this figure is showing multi-channel audio coding in an HOA domain, whereby one or more channels of the multi-channel audio are encoded in the HOA domain for transmission to the decoder-side device 12. The encoder-side device 11 may have several operational blocks, such as a splitter 32, an LFE encoder 35, the audio encoder 21, a channel converter 34, a speaker position extractor 33, and the metadata encoder 22. As shown, the encoder-side device 11 may receive audio content in a surround-sound format, which may include metadata based on the format. In particular, the audio content may include multi-channel audio 31 and metadata 15 associated with the audio 31. The encoder device 11 receives the audio 31, as one or more input audio signals, where the audio 31 may include one or more, K, surround-sound channels. For example, the audio 31 may include eleven channels, when the audio 31 is in a 7.1.4 format, or may include six channels when the audio 31 is in a 5.1 format. In which case, the audio 31 may include one or more full-range channels (e.g., channels that are to be played back by surround sound speakers of a surround sound system), and/or may include one or more LFE or band-limited channels, which may be arranged to be played back by a loudspeaker, such as a subwoofer. Turning to the metadata 15, this information may indicate the channel layout of the multi-channel content, such as indicating whether the audio content is 5.1 surround sound audio or 7.1.4 surround sound audio. In another aspect, the layout may indicate which channel is associated with a particular speaker, such as indicating whether a channel is associated with a front center speaker.

The splitter 32 may be configured to receive the multi-channel audio 31, and may be configured to split (or separate) the different types of channels from each other. In particular, the splitter may receive the metadata 15, which may indicate which channels are full-range and which channels are band-limited. In particular, using the metadata 15, the splitter 32 may be configured to separate and output the K channels of the audio 31 into Q number of LFE (or band-limited) channel(s) 51 and R number of non-LFE (or full-range) channel(s) 52. For example, when the multi-channel audio 31 is 5.1 surround sound audio, Q is one channel, while R is five channels.

The speaker position extractor 33 may be configured to receive the metadata 15 and extract positions of speakers 53 (e.g., the channel layout) associated with each of the channels of the audio 31. In one aspect, the speaker positions may be a position of the speaker relative to a listener position. In one aspect, the extracted positions may include azimuth and/or elevation angles. In another aspect, the extracted positions may include a distance from the listener position to the speaker position. In one aspect, the extractor may determine this information based on the metadata. In particular, the extractor 33 may determine the surround-sound format of the audio 31, and may derive the speaker positions based on that format. For example, upon determining that the audio 31 is 5.1 surround sound format, the extractor may perform a table lookup into a data structure that indicates speaker position(s) for each full-band channel based on the format of the audio. In another aspect, the metadata may include the speaker positions. In which case, the extractor may retrieve the information from the metadata.

The channel converter 34 may be configured to receive the non-LFE channel(s) 52 and convert the channels into a HOA representation 58 based on the metadata 15 (e.g., surround-sound speaker layout information). In particular, the converter may receive the speaker positions 53 and may generate a channel (CH)-to-HOA conversion spherical harmonics (SPH) matrix based on the speaker positions 53 of, or more specifically the directions associated with, the non-LFE channels 52. In particular, the SPH matrix, which when applied to the non-LFE channels(s) 52 produces corresponding HOA signals, as spherical harmonic signals (or functions) of the HOA 58. Thus, the HOA 58 may be the result of the application of the conversion matrix by the converter 34 to the channels 52.

As described herein, the audio encoder 21 may be configured to receive the HOA 58 and encode the HOA representation using MP coding-based algorithm into the bitstream 13, along with the encoded metadata by the metadata encoder 22. The LFE encoder 35 may be configured to receive the one or more, Q, LFE channel(s) 51 extracted from the audio 31 and may encode the channels into the bitstream 13, using any codec. In some aspects, the encoder may use any suitable audio codec, such as, e.g., Advanced Audio Coding (AAC), MPEG Audio Layer II, MPEG Audio Layer III, or Free Lossless Audio Codec (FLAC). As a result, the LFE channels 51 may be encoded into the bitstream 13 separately from the HOA representation 58 that represents the non-LFE channels 52. In one aspect, the encoded HOA representation, the LFE channel, and the metadata may be transmitted to the decoder-side device 12 as the bitstream 13. In another aspect, each may be transmitted in separate bitstreams and/or may be transmitted at different times from one another.

Thus, as described thus far, the encoder-side device, based on the metadata of the multi-channel audio, or more specifically the channel layout, LFE channels 51 may be encoded by an LFE coding tool (e.g., where the encoder 35 uses a coding algorithm for encoding band-limited channels). Based on the channel layout, non-LFE channels 52 may be converted to converted audio, e.g., HOA 58 by multiplying a CH-to-HOA conversion matrix that is generated by the SPHs for non-LFE speaker positions 53. The converted audio may be encoded by the audio encoder 21 (e.g., using the MP coding-based algorithm). The metadata 15 may be encoded by the metadata encoder 22, and each of the encoded elements may be transmitted via the bitstream 13 to the decoder-side device 12.

The decoder-side device 12 includes an LFE decoder 36, the audio decoder 23, the metadata decoder 25, the speaker position extractor 33, the channel converter 37, and a merger 39. The decoder-side device receives the encoded bitstream 13 that includes an encoded HOA signal, one or more encoded LFE channels, and encoded associated metadata. The metadata decoder 25 decodes the encoded metadata and produces (e.g., a reconstruction of) the metadata 15. The audio decoder 23 produces a decoded HOA signal (e.g., HOA 58) using the MP coding-based algorithm, as described herein. In addition, the LFE decoder 36 is configured to produce (or reconstruct) the LFE channels 51 by decoding the encoded LFE channels within the bitstream 13.

As described herein, the speaker position extractor 33 receives the metadata 15 and produces speaker positions 53 of the non-LFE channels 52. The channel converter 37 receives the positions (layout) 53 and generates a HOA-to-CH conversion SPH matrix based on the positions 53. In one aspect, the HOA-to-CH conversion matrix may be a pseudo-inverse of the CH-to-HOA conversion matrix generated by the channel converter 34 at the encoder-side device 11 to convert the non-LFE channels 52 into the HOA 58. The converter 37 receives the HOA signal 58 form the decoder 23 and converts the HOA signal (e.g., back) into the non-LFE channel(s) 52 using the HOA-to-CH conversion matrix that is generated based on the metadata 15.

The merger 39 may be configured to receive the reconstructed LFE channel(s) 51 and the reconstructed non-LFE channel(s) 52, and may be configured to merge the channels into several surround-sound channels in a surround-sound format based on the metadata 15. In particular, the merger reconstructs the multi-channel audio 31, which includes the K channels, and may be in the original surround-sound format, such as 5.1 surround-sound format. The reconstructed audio 31 may then be sent to the renderer 16, which may then use the channels to drive the speakers 17 according to its format. In particular, based on the layout of the speakers 17, the renderer may spatially render the multi-channel audio 31 to the speakers 17. Thus, this figure provides coding operations that allows multi-channel audio to be encoded and transmitted to a decoder-side device, which may then reconstruct the original multi-channel audio for playback.

Thus, as described herein, based on the received bitstream 13, the decoder-side device 12 may decode LFE channels, the HOA signal 58, and the metadata 15. The decoder-side device may reconstruct the non-LFE channels 52 by multiplying the HOA signal 58 by an HOA-to-CH conversion matrix that may be generated by a pseudo-inverse of SPHs for the speaker position 53, where the matrix is a pseudo-inverse with respect to the encoder-side matrix that was used by the encoder-side to originally convert the non-LFE channels into the HOA signal 58. Based on the metadata 15, or more specifically the channel layout of the multi-channel audio 31, the decoded LFE channel 51 and the non-LFE channels 52 may be placed to the correct channel locations (e.g., within a surround-sound format).

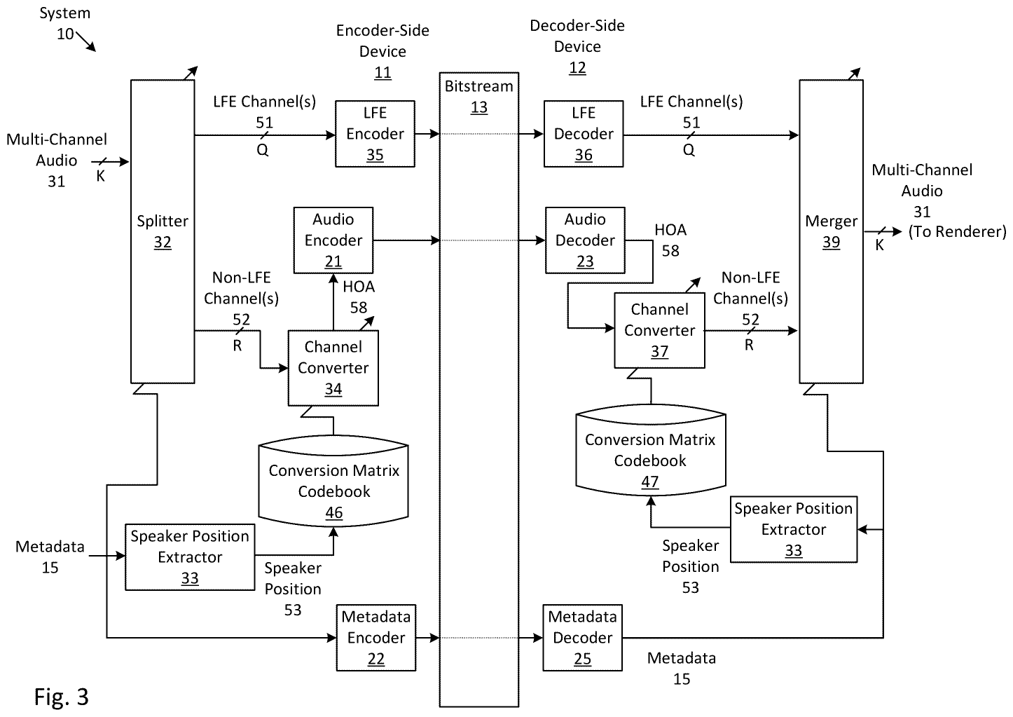

FIG. 3 shows a block diagram of the system 10 for encoding and decoding multi-channel audio 31 using conversion matrix codebooks for converting the audio into a HOA format according to one aspect. As shown, this figure is similar to FIG. 2, except that this figure the encoder-side device 11 includes a conversion matrix codebook 46 and the decoder-side device 12 includes a conversion matrix codebook 47. As described herein, the encoder-side device 11 audio content (e.g., audio 31) in a surround-sound format, such as 5.1 surround sound that includes metadata 15 based on the format (e.g., indicating the speaker layout of the 5.1 format), where the content includes several (K) surround-sound audio channels. The splitter 32 splits the K channels into several full-range or non-LFE channels 52 and into at least one LFE channel 51 based on the metadata 15. In one aspect, a “full-range” audio channel may be an audio channel that includes spectral content along a wider frequency range than the LFE channel 51. In another aspect, the full-range channel may be configured to provide audio content along an entire audible frequency range, when used to drive a full-range driver speaker.

The conversion matrix codebook 46 may be a data structure (e.g., table) that includes CH-to-HOA conversion matrices, which may have been previously generated (e.g., in a controlled environment, such as a laboratory). In one aspect, the codebook may include SPH matrices based on speaker positions, which when applied to multi-channel audio content may convert the content into an order of ambisonics in a HOA format, as described herein. In one aspect, the codebook 46 may associate different matrices with different speaker positions. Thus, the encoder-side device may be configured to determine and retrieve a conversion matrix from the codebook 46 that is associated with the speaker position 53 (e.g., surround-sound speaker layout), e.g., by performing a table lookup using the position 53 extracted by the extractor 33. The channel converter 34 receives the channels 52 and converts them into a HOA representation 58 using the retrieved conversion matrix (e.g., by applying the matrix to the channels 52), and encodes the HOA representation using MP coding-based algorithm into the bitstream 13 for transmission to the decoder-side device 12.

In one aspect, based on the channel layout indicated by the metadata 15, LFE channel(s) 51 are encoded (separately) by the LFE encoder 35 into the bitstream 13. In addition, based on the channel layout, non-LFE channels 52 are converted to HOA 58 by multiplying a CH-to-HOA conversion matrix that is stored in the codebook 46, where the HOA 58 is encoded by the audio encoder 21 into the bitstream 13, along with the metadata.

Turning to the decoder-side device 12, the device 12 receives one or more HOA signals, one or more LFE channels, and metadata as the encoded bitstream 13, and extracts the data from the bitstream 13, where the HOA signals are extracted by using the MP coding-based algorithm to decode the HOA signals. Similar to the encoder-side device 11, the decoder device 12 may use the codebook 47 to retrieve a conversion matrix to convert the decoded HOA 58 back into (e.g., to reconstruct) the non-LFE channels. In particular, the codebook 47 may be a data structure that includes HOA-to-CH conversion matrices, where each matrix may be associated with (e.g., different) speaker positions. Thus, the codebook 47 may include inverse matrices than those of the codebook 46 of the encoder-side device 11. In one aspect, both codebooks may include both groups of matrices (e.g., CH-to-HOA matrices and corresponding HOA-to-CH matrices), such that either device may perform encoding and decoding operations. Thus, the decoder-side device 12 retrieves, from the codebook 47 stored in memory of the device 12, an HOA-to-CH conversion matrix based on the metadata 15. In particular, the device 12 may perform a table lookup into the codebook 47 using the speaker position 53 extracted from the metadata. The channel converter 37 of the device 12 produces (reconstructs) the non-LFE channels 52 by applying the conversion matrix form the codebook 47 to the extracted HOA 58 from the bitstream 13. The merger 39 then produces the multi-channel audio 31 by merging the extracted LFE channel(s) 51 and the non-LFE channel(s) 52.

Thus, based on the received bitstream 13, LFE channel(s) 51, HOA 58, and metadata 15 are decoded. Non-LFE channels 52 are reconstructed by multiplying the HOA 58 by the HOA-to-CH conversion matrix that is stored in the codebook 47, and based on the metadata, the decoded LFE channel(s) and non-LFE channel(s) are placed to the correct channel locations.

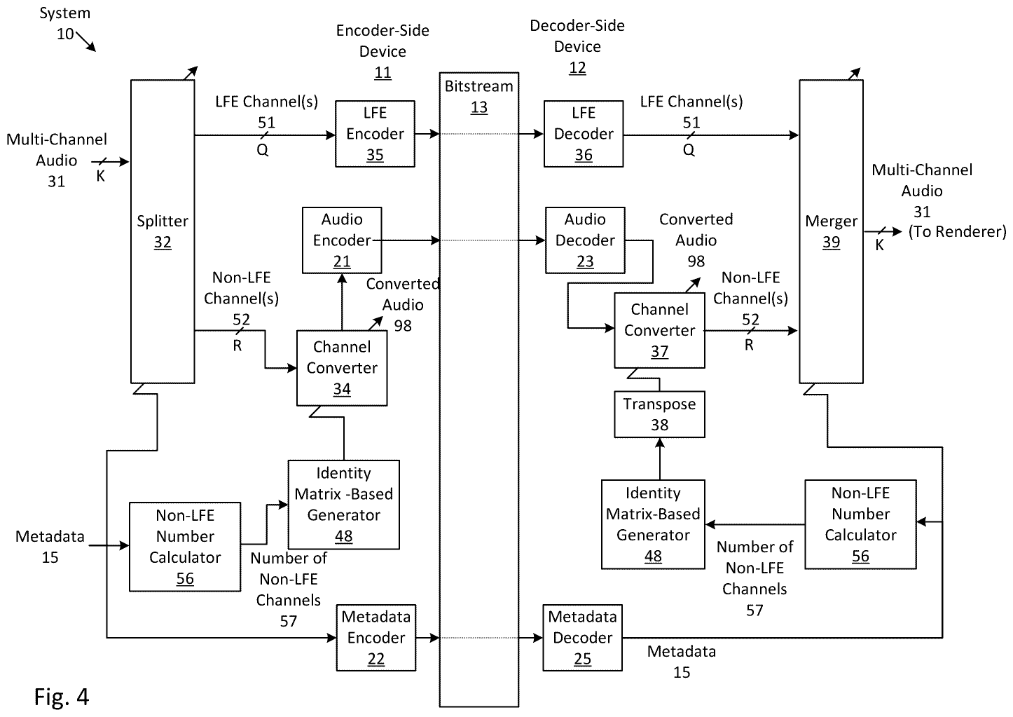

FIG. 4 shows a block diagram of the system 10 for encoding and decoding multi-channel audio using a conversion matrix based on an identity matrix based on the number of surround-sound audio channels of the channel audio according to one aspect. As shown, this figure is similar to FIG. 2, except that in this figure the encoder-side device 11 includes a non-LFE number calculator 56 (which may be configured to perform at least some of the operations of the extractor 33) and an identity matrix-based generator 48, and the decoder-side device 12 includes the non-LFE number calculator 56, the identity matrix-based generator 48, and a transpose 38. As described herein, the encoder-side device 11 receives the audio content in a surround-sound format (e.g., 5.1 surround-sound format) that includes metadata 15 and several multi-channel audio channels 31, wherein the encoder device separates the LFE channels from the other (e.g., full-range) audio channels based on the metadata 15. The non-LFE number calculator 56 may be configured to receive the metadata and determine a number of non-LFE channels 57 that were received with the audio 31. For example, the calculator may determine the number based on the channel layout of the surround-sound format. For example, with a 5.1 surround-sound format, the calculator may determine that there are five non-LFE audio channels.

The identity matrix-based generator 48 may be configured to generate a conversion matrix based on the number of LFE channels. In particular, the generator 48 receives the number of non-LFE channels 57 that is included within the multi-channel audio 31 and determines a HOA order that is associated with an equal or greater number of HOA channels. For example, a 1st order ambisonics has four channels of audio, while a 2nd order ambisonics has nine channels of audio. In the case in which the number of channels 57 indicates that the multi-channel audio 31 has five channels (e.g., 5.1 surround-sound format), the generator 48 selects a 2nd order ambisonics, which has nine channels and generates an identity matrix based on the selection. In particular, the generator 48 may be configured to generate an identity matrix with an order that is based on the number of non-LFE channels, which in this case would be a 5th order identity matrix (e.g., 5×5 matrix. The generator 48 generates a conversion matrix by adding additional columns to the identity matrix, such that the total number of columns equals the number of ambisonics channels. In one aspect, the additional columns would have values of zero, such that each of the elements are 0. An example conversion matrix generated by the generator 48 for five non-LFE channels may be:

$$Conversion Matrix = [ \begin{matrix}1 & 0 & 0 & 0 & 0 & 0 & 0 & 0 & 0 \\ 0 & 1 & 0 & 0 & 0 & 0 & 0 & 0 & 0 \\ 0 & 0 & 1 & 0 & 0 & 0 & 0 & 0 & 0 \\ 0 & 0 & 0 & 1 & 0 & 0 & 0 & 0 & 0 \\ 0 & 0 & 0 & 0 & 1 & 0 & 0 & 0 & 0\end{matrix} ]$$

The channel converter 34 may be configured to receive the non-LFE channels 52 and multiplies the generated conversion matrix (e.g., having at least five diagonal elements of “1”) by the non-LFE channels 52 to produce a matrix with the non-LFE channels 52 assigned to at least one of column of the conversion matrix. For example, in the case of having five non-LFE channels 52, each of the first five columns may be assigned one of the non-LFE channels. In addition, the converter 34 may assign four additional channels to the non-assigned four columns of the conversion matrix, such that the resulting matrix has nine total channels assigned, five non-LFE channels and four additional channels. In one aspect, the additional channels do not include the multi-channel audio content. This resulting matrix may allow the audio encoder to perform the MP coding-based algorithm to encode the audio data, as described herein. In one aspect, the non-LFE channels may be converted by the conversion matrix into a HOA representation (e.g., a H matrix) of the non-LFE channels (and the additional channels), which in this case may be a 2nd order ambisonics representation, where five of the HOA signals may be assigned to the non-LFE audio channels and four of the remaining HOA signals may be assigned to additional channels that do not include the audio content, as described herein. In one aspect the additional channels may not include any data. In particular, the channel converter applies the conversion matrix to the channels 52 and produces converted audio 98 (e.g., which may be HOA signals). The converted audio 98 may be encoded by the audio encoder, using the MP coding-based algorithm, into the bitstream 13, as described herein.

In one aspect, based on the metadata 15 (e.g., the channel layout of the multi-channel audio 31), LFE channels are encoded by a the LFE encoder 35 (e.g., using a LFE coding algorithm). Based on the metadata, non-LFE channels may be converted to the converted audio by multiplying an identity matrix-based conversion matrix to the non-LFE channels. If the number of non-LFE channels, R, and the number of converted audio channels, e.g., L, N and L N channels of the converted audio may be filled with the non-LFE channels and zeros, respectively. The converted audio may be encoded by the MP coding-based algorithm. In one aspect, the encoded LFE channels, converted audio, and metadata may be transmitted via one or more bitstreams 13 to the decoder-side device.

The decoder-side device 12 receives the encoded bitstream 13, which may include the LFE channels 51 of a piece of surround-sound audio content, the metadata 15, and the converted audio 98 (or audio content), which may include several channels that were generated by applying a conversion matrix that is based on an identity matrix based on the metadata to the non-LFE surround-sound channels (e.g., channels 52) of the piece of surround-sound audio content, where the channels of the encoded audio content within the bitstream may include the non-LFE surround-sound channels and at least one additional channel that does not include audio data. In particular, as described herein, the number of channels within the encoded audio content within the bitstream may equal the number of channels of a given order of ambisonics that is at least equal to the number of channels of the piece of surround-sound audio content. In the case in which the number of channels of the given order of ambisonics is more, additional channels may be added, where the additional channels may not include audio data of the surround-sound content.

The decoder-side device 12 may be configured to determine the conversion matrix, using the generator 48, which was used to produce the converted audio at the encoder-side device by the channel converter 34 (e.g., a 5×9 matrix, which includes a 5th order identity matrix, when the piece of surround-sound audio content is a 5.1 surround-sound format). The transpose 38 receives the conversion matrix and produces a transpose of the identity matrix. The channel converter 37 receives the decoded converted audio 98 from the audio decoder 23 and reconstructs the non-LFE surround-sound channels and the at least one additional channel by applying the transpose of the conversion matrix to the converted audio 98. The decoder-side device 12 may merge the LFE channels 51 and the non-LFE channels 52 to reconstruct the multi-channel audio 31 (which may include the metadata 15), and may (send this to the renderer 16) to be used to drive the speakers 17. In one aspect, the channel converter 37 may truncate (or discard) the additional channels.

In one aspect, based on the received bitstream 13, LFE channel(s), converted audio (which may include surround sound audio and additional content), and metadata are decoded. From the decoded metadata 15, the number of non-LFE channels 57 is calculated. Non-LFE channels 52 are reconstructed by multiplying the decoded converted audio 98 by the transpose of the identity matrix-based conversion matrix (and by removing the last additional channels of the converted audio that do not include audio data of the multi-channel audio). Based on the metadata, the decoded LFE channels and the reconstructed non-LFE channels may be placed to the correct channel speaker locations by the renderer 16.

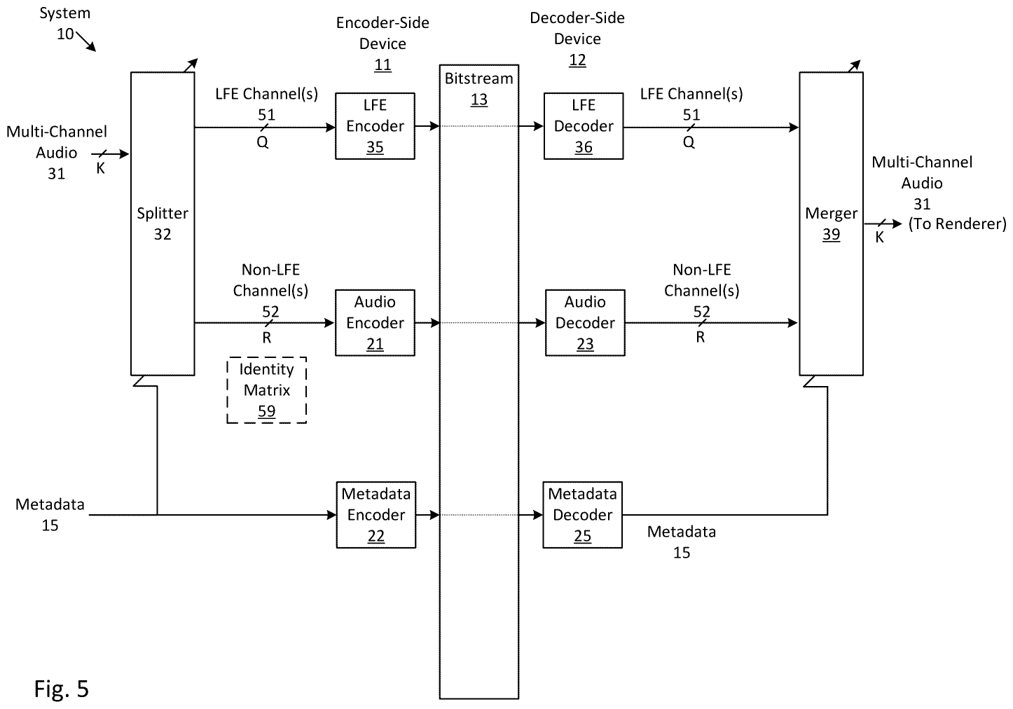

FIG. 5 shows a block diagram of the system 10 for encoding and decoding multi-channel audio according to one aspect. In particular, this figure shows that the non-LFE channels 52 of the multi-channel audio 31. In particular, the audio encoder 21 may receive the non-LFE channel(s) 52 and encode the channels directly, using the MP coding-based algorithm. In which case, the encoder-side device 11, or more specifically, the LFE encoder 35 and the metadata encoder 22 may encode the LFE channel(s) 51 and the metadata 15, respectively, into the bitstream 13 along with the encoded non-LFE channels 52. In one aspect, the encoder-side device 11 may apply the non-LFE channels 52 to an (optional) identity matrix 59, e.g., having an order based on the number of non-LFE channels, such that the resulting matrix may be encoded by the audio encoder, as described herein. Thus, based on the metadata, LFE channels may be encoded by the LFE encoder, the non-LFE channels may be encoded by the MP coding-based algorithm, and the metadata may be encoded by the encoder 22, where the encoded data is transmitted through the bitstream 13.

The decoder-side device 12 may be configured to receive the encoded bitstream that includes the non-LFE (surround-sound) channels, the LFE channel(s), and/or the metadata 15, where the content may be extracted (e.g., by the decoders 36, 23, and/or 25) by performing one or more decoding algorithms, which include using the MP coding-based algorithm. Based on the metadata 15, the decoded channels are merged to produce the (original) multi-channel audio 31 (in the surround-sound format). As a result, the LFE and non-LFE channels may be placed in the correct channel locations, as described herein.

As described herein, the system 10 may split LFE channels from non-LFE channels, and encode both into the bitstream 13. In one aspect, LFE channels may be optional channels. In particular, the multi-channel audio 31 may not include LFE channels. In one aspect, the multi-channel audio may be several (e.g., full-range) channels of audio content (e.g., which may or may not be in a surround-sound format). In which case, the multi-channel audio may be passed into the channel converter 34 for conversion and for encoding. In this case, the bitstream 13 may include a HOA representation of the non-LFE channels and metadata, without having encoded LFE channels. As a result, the decoder-side device 12 may convert the HOA representation back to the non-LFE channels and use the channels, without LFE channels, for rendering the audio content.

As described thus far, the system 10 may be configured to convert multi-channel audio into a different audio format and transmit an encoded version of the multi-channel audio to a decoder-side device, which may decode and reconstruct the original multi-channel audio for rendering. This has several advantages. For example, along with transmitting the audio, associated metadata may be transmitted as well, both of which allow audio processing operations to be performed upon the original audio (e.g., the audio received by the encoder side device 11). This provides the decoder-side flexibility in which audio signal processing operations may be performed at the decoder-side device. This is in contrast to receiving audio that is already processed by an encoder-side device, thereby not allowing the decoder-side device to undo some processes that had already been performed. In addition, by encoding the audio data using an MP coding-based algorithm, encoded audio data may efficiently be transmitted through the bitstream 13, even in bitrate reduction situations, while keeping a high audio quality.

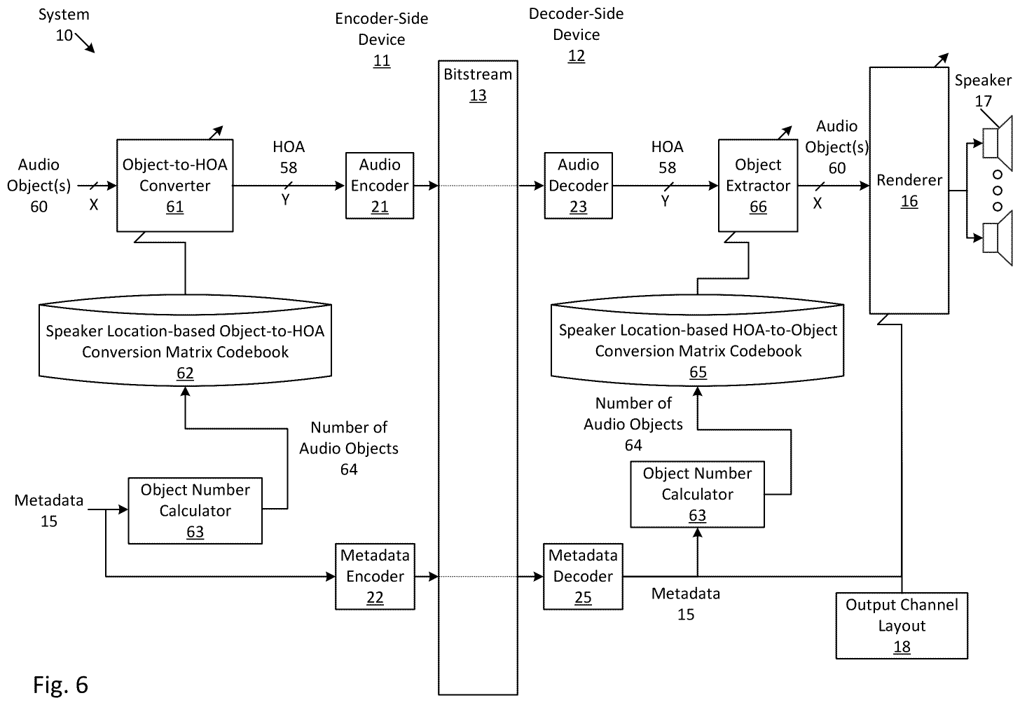

FIGS. 6-10 relate to performing coding operations upon one or more audio objects, where the audio objects may be associated with one or more pieces of audio content.

FIG. 6 shows a block diagram of the system 10 for encoding and decoding audio objects using a conversion matrix codebook for assigning the audio objects into speaker locations for conversion into a HOA format according to one aspect. The encoder-side device 11 may include several operational blocks, such as an object-to-HOA converter 61, the audio encoder 21, a speaker location-based object-to-HOA conversion matrix codebook 62, an object number calculator 63, and the metadata encoder 22. The encoder-side device 11 may be configured to receive a set of one or more audio objects 60, where each object may include one or more audio signals that include sound of a sound source and metadata 15 (e.g., positional data) that may indicate the position of the respective (e.g., audio object of the) sound source with respect to a reference point (e.g., listener location) in an acoustic environment. The object number calculator 63 may be configured to receive the metadata 15 and determine, based on the associated metadata, a number of audio objects 64 of the objects 60. In one aspect, when each of the audio objects includes one audio signal, the number 64 may be of the received audio signals. In one aspect, the number 64 may be more than the number of audio objects 60, when one or more objects includes one or more audio signals. In one aspect, the object number calculator 63 may determine the number of objects 64 based on the positional data (e.g., based on the number of pairs of azimuth and elevation angles).

The speaker location-based object-to-HOA conversion matrix codebook 62 may be a data structure that stores object-to-HOA conversion matrices, which when applied to one or more audio objects may convert the objects into an order of ambisonics, as described herein. In one aspect, the codebook may include SPH matrices, which when applied to multi-channel audio, based on the speaker locations of the multi-channel audio, may convert the audio into ambisonics, as described herein. Thus, the codebook may include different conversion (SPH) matrices based on the number of speaker channels (or more specifically speaker locations associated with the channels, such as for different surround-sound formats, such as 5.1, 7.1, 7.1.4, etc.). In one aspect, the codebook may specify speaker locations associated with the conversion matrices based on MPEG Coding Independent Code Points (CICP) speaker layout index values for different speaker layouts.

The encoder-side device 11 may be configured to determine (or select), based on the number of audio objects 64, a conversion matrix from the codebook 62, such that the 1) each audio signal of the audio objects 60 may be mapped to a surround-sound speaker position of the speaker positions of the selected matrix, where a number of speaker positions of the conversion matrix may be greater than or equal to a number of audio signals of the audio objects. For example, if there are five audio object signals, the encoder-side device may select a conversion matrix with speaker positions associated with the non-LFE audio channels of 5.1 surround sound audio format, where each of the 5 surround-sound locations may be associated with one of the five audio object signals.

If, however, the number of audio objects is different from the number of speaker positions of a conversion matrix, the device may select a conversion matrix in which the number of speaker locations may be greater than the number of audio object speakers, but so that the number of excess speaker locations may be minimized. For example, when six audio object signals are received, the encoder-side device 11 may use the number of audio objects 64 to select a conversion matrix with speaker positions for 7.1 surround-sound format, as opposed to 7.1.4 surround-sound format, since 7.1 has seven non-LFE speaker positions, whereas 7.1.5 has eleven non-LFE speaker positions. In particular, to make this selection, the encoder-side device may perform a table lookup using the number of audio objects 64 into the codebook 62 to select the conversion matrix, as described herein.

The Object-to-HOA converter 61 receives audio signals, X signals, of the audio objects 60, and produces a HOA representation 58, having Y HOA signals 58, of the objects by applying the conversion matrix from the codebook 62 to the objects 60. In particular, the matrix maps the objects 60 into the speaker positions (e.g., thereby putting the objects in the multi-channel domain) and then the objects are converted into the HOA domain according to the spherical harmonics of the matrix. Thus, the conversion matrix is for 1) mapping each audio signal of the audio objects to a surround-sound speaker position and 2) converting the objects to a HOA representation according to the speaker positions. The audio encoder 21 receives the HOA representation 58 and encodes it using MP coding-based algorithm into the bitstream 13 that may include the associated encoded metadata (e.g., by encoder 22).

In one aspect, based on a set of different non-LFE speaker locations, object-to-HOA conversion matrices using SPH may be generated and stored in the codebook 62, where speaker locations may be specified with CICP indices. Thus, the codebook 62 may include different matrices for different speaker locations (layouts). Based on the number of audio objects 64, X, an object-to-HOA conversion matrix which has one or more non-LFE speaker positions may be selected from the codebook 62. For example, a matrix may be selected such that the number of non-LFE speaker positions is already greater than or equal to the number of objects 64, while also maintaining that the difference between the number of non-LFE positions and the number of objects is minimized (e.g., in order to reduce required bandwidth). The object audio signals may be converted to ambisonics (e.g., HOA 58) by multiplying the selected conversion matrix to the audio object signals 60. The HOA 58 may be encoded, along with the metadata 15, and transmitted to the decoder-side device via the bitstream 13.

The decoder-side device 12 may include the audio decoder 23, an object extractor 66, the renderer 16, a speaker location-based HOA-to-Object conversion matrix codebook 65, the object number calculator 63, the metadata decoder 25, and the output channel layout 18. As described herein, the decoder-side device 11 receives the encoded bitstream 13 that may include a converted audio (e.g., HOA) representation of audio content and associated metadata from the encoder-side device. The metadata decoder 25 produces decoded metadata 15 from the bitstream, and the object number calculator 63 is configured to determine the number of audio objects 64 that are being represented by the HOA representation received within the bitstream 13.

The speaker location-based HOA-to-Object conversion matrix codebook 65 may be a data structure that stores conversion matrices for converting HOA data into one or more audio objects. In particular, the codebook may include pseudo inverse SPH matrices of the matrices stored by the codebook 62 at the encoder-side device 11. In one aspect, each of the codebooks 62 and 65 may store both types of matrices. Thus, the codebook 65 includes different conversion SPH matrices based on the number of speaker channels (or more specifically speaker locations associated with the channels). The decoder-side device 12 may select a conversion matrix from the codebook 65 based on the number of audio objects 64, and based on the previously mentioned criteria with respect to the selection of the conversion matric from the codebook 62. For example, the selected pseudo inverse conversion matrix may be associated with a speaker layout that includes a number of speaker locations that is greater than or equal to the number of objects 64, where the difference between the number is minimized.

The object extractor 66 receives the HOA representation 58 and the selected conversion matrix from the codebook 65, and produces one or more audio objects 60 from the HOA 58 using the conversion matrix (e.g., multiplying it by the HOA representation 58). Thus, the conversion matrix may convert the HOA representation into several surround-sound audio channels and reconstruct the audio objects from the surround-sound audio channels.

In one aspect, each audio object signal may be assigned to a particular speaker location. In which case, the audio objects may be reconstructed by extracting their respective signals from the converted surround-sound audio channels. In one aspect, any excess surround-sound audio channels (e.g., based on the number of audio objects being less than the surround-sound speaker positions and not including audio object data) may be discarded.

The renderer 16 receives the audio objects 60, the metadata 15, and the output channel layout 18, which indicates the layout of the speakers 17 (e.g., indicating whether the speakers are headphones or a layout of one or more loudspeakers), and may spatially render loudspeaker or headphone driver signals (e.g., based on the layout 18) using the audio objects and metadata. In one aspect, the renderer may render the audio objects in real-time, meaning the objects may be rendered as they are being received through the bitstream 13 with minimal amount of time in between (e.g., taking in to account processing time). In another aspect, the audio objects may be stored in memory of the decoder-side device 12 for later rendering.

In another aspect, at least some of the processes described herein may be performed in real-time. For example, the pseudo inverse conversion process may be performed in real-time, as the HOA 58 is decoded by the audio decoder 23, by the object extractor 66. In which case, the extractor 66 may receive the number of audio objects 64 and extract the objects accordingly. In which case, the codebook 65 may be optional.

In one aspect, the pseudo inverse of all code vectors in the object-to-HOA matrix codebook 62 may be stored in the speaker location-based HOA-to-Object conversion matrix codebook 65. Based on the received bitstream, the HOA 58 and the metadata 15 is decoded. Based on the number of converted surround-sound channels of the HOA 58 and the number of audio objects indicated by the metadata 15, a conversion matrix from the codebook 65 is selected, where the number of surround-sound speaker positions associated with the selected matrix is greater than or equal to the number of audio objects and is also minimized. The audio objects 60 may be reconstructed from the HOA 58 by multiplying the HOA 58 with the selected conversion matrix. Based on the audio object signals and the metadata, object rendering by the renderer 16 produces one or more output signals for the speakers 17.

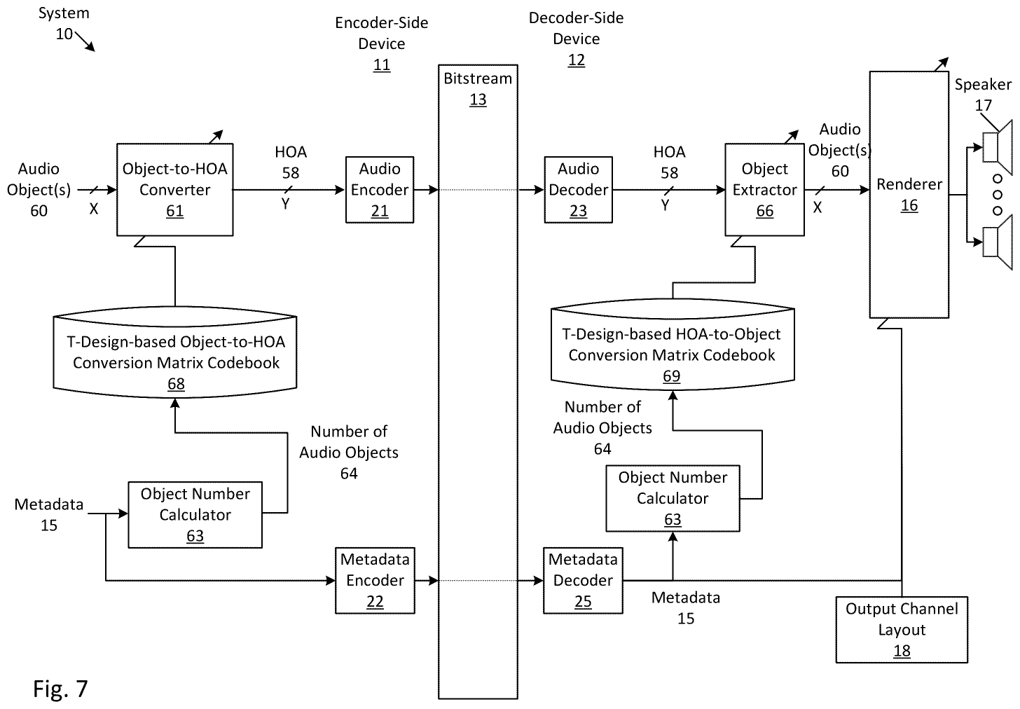

FIG. 7 shows a block diagram of the system 10 for encoding and decoding audio objects using a conversion matrix codebook for assigning the audio objects into speaker locations for conversion into a HOA format according to another aspect. In particular, this figure relates to encoding audio objects by mapping the objects to speaker locations that are arranged as T-design points along a spherical surface (or projection grid). In particular, the encoder-side device includes a T-design-based Object-to-HOA conversion matrix codebook 68 for converting one or more audio objects to converted (e.g., HOA) data for encoding and transmitting as the bitstream 13.

In one aspect, a set of n points may be called a spherical T-design if the integral of any polynomial of degree at most t over the spherical grid is equal to the average value of the polynomial over the set of n points. In some aspects, the points may be associated with speaker locations, where the locations may be positioned along a spherical projection grid (or a surface of the sphere). In one aspect, the spherical projection grid may be a sphere that may be about a reference point, e.g., a listening position. In one aspect, several conversion matrices for the codebook 68 may be generated, where each matrix may account for a (e.g., different) number of speaker locations about a sphere. For example, several spherical projection grids may be generated, where each spherical projection gird may have a different number of speaker locations on a surface of the spherical projection grid according to a spherical T-design (e.g., for a given T-design index). For each spherical grid, a conversion matrix may be generated and stored in the codebook 68, where the matrix may convert one or more audio objects to a HOA using spherical harmonics of the respective number of speaker locations. In particular, the conversion matrix may be for converting audio objects using spherical harmonics of locations that map to T-design speaker locations of the matrix.

In one aspect, the encoder-side device 11 may use the codebook 68 to convert audio objects 60 to the HOA 58. In particular, the encoder-side device may select (retrieve) a conversion matrix from the codebook 68 based on the number of audio objects 64. In one aspect, the encoder-side device may select a conversion matrix in which a number of associated speaker locations of the T-design is greater than or equal to the number of audio objects 64, and that the difference between the number of locations and the objects 64 is minimal (e.g., as close to or is zero as possible). As described herein, with the selected conversion matrix, the object-to-HOA converter 61 may apply the conversion matrix to the audio objects 60 to produce the HOA representation 58 of the audio objects.

As described herein, the encoder-side device 11 may generate conversion matrices for the codebook 68 (or they may be previously generated). In one aspect, for a given T-design index (e.g., number of points), speaker locations may be specified (e.g., at locations of points of a particular T-design size, such as 50 speaker locations for 50 points). For the given T-design index, an object-to-HOA conversion matrix using the SPH of the set of speaker locations may be generated and stored in the codebook 68. In one aspect, several conversion matrices may be generated for different T-design indices.

Based on the number of audio objects 64, a T-design index may be selected, where the number of speaker locations of the index may be greater than or equal to the number of objects 64 and the difference between the two numbers may be minimal (e.g., zero or as close or zero as possible). The audio object signals may be converted to converted audio (e.g., HOA 58) by multiplying the selected object-to-HOA conversion matrix. The HOA 58 and metadata 15 of the audio objects 60 may be encoded and transmitted via the bitstream 13, as describe herein.

The decoder-side device 12 includes a T-design-based HOA-to-Object conversion matrix codebook 69, which may include conversion matrices that are configured to convert converted audio (e.g., HOA 58) back into one or more audio objects. In particular, the codebook 69 may include inverse or transpose matrices of those in the codebook 68 of the encoder-side device 11. In one aspect, each of the codebooks 68 and 69 may include either or both groups of conversion matrices. In which case, the decoder-side device 12 receives the bitstream with the encoded HOA data and encoded audio object metadata for one or more audio objects. The decoder-side device decodes the HOA data, and selects a (e.g., inverse) conversion matrix from the conversion matric codebook 69 based on the number of audio objects 64 according to the metadata. The object extractor 66 produces the audio objects 60 that are reconstructed from the HOA 58 by applying the selected matrix to the decoded HOA data.

In one aspect, the conversion matrix may reconstruct the audio objects by converting the HOA data into a number of (e.g., surround-sound) speaker channels according to the speaker locations (of a T-design index based on the number of audio objects). From the speaker channels, and based on the metadata, the extractor may reconstruct the audio object audio signals.

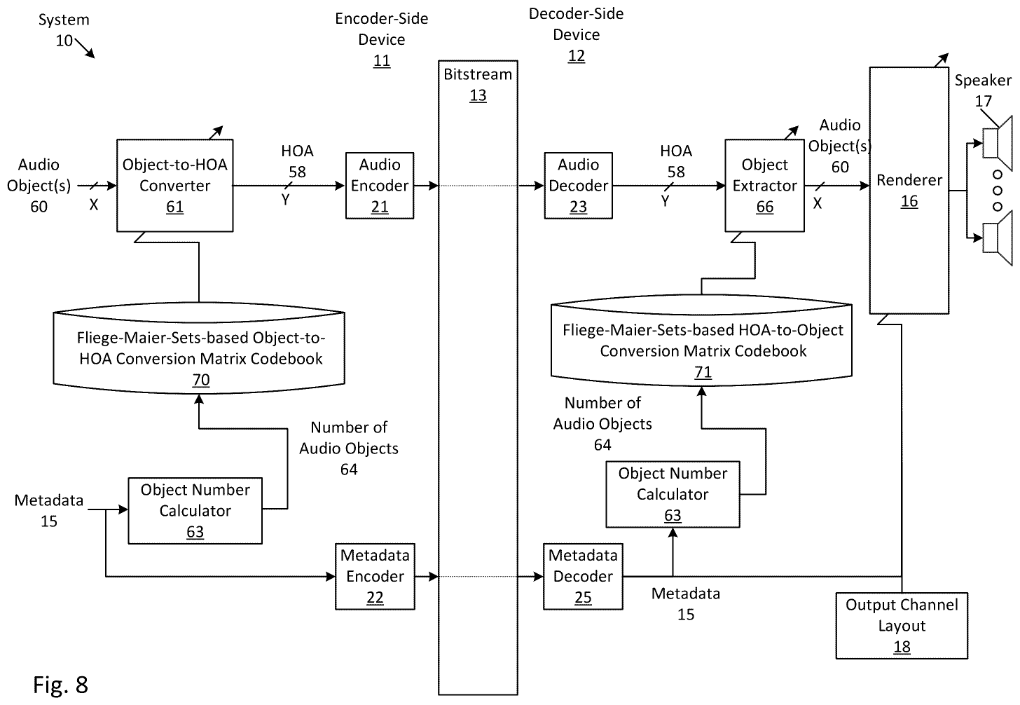

FIG. 8 shows a block diagram of the system 10 for encoding and decoding audio objects using a conversion matrix codebook according to another aspect. In particular, this figure includes similar features of FIG. 7, except that instead of having T-design-based conversion matrix codebooks 68 and 69 at the encoder and decoder, respectively, this figure includes Fliege-Maier-Sets conversion matrix codebooks. As described herein, T-design may be an arrangement of points (or speaker locations) that are on a surface of a sphere. Fliege-Maier-Sets may be another uniform arrangement (or distribution) of speaker locations along a spherical grid. In one aspect, the speaker locations of the Fliege-Maier-Sets may be equidistant about the spherical grid and around a reference point (e.g., a center of the sphere being a listening position).

In one aspect, the codebooks 70 and 71 of this Figure may be produced similarly as the codebooks of FIG. 7. For example, for a given Fliege-Maier-Set index, indicating a number of points, speaker locations may be specified. In particular, a spherical projection grid may be generated having a number of speaker locations on a surface of the gird according to a Fliege-Maier set. For the index, a conversion matrix may be generated and stored in the codebook 70 for converting one or more audio objects to HOA using spherical harmonics of the speaker locations of the spherical grid. Based on this, multiple conversion matrices may be generated for different indices (e.g., to account for different numbers of speaker locations). In one aspect, the codebook 71 of the decoder-side device 12 (and/or the codebook 70 of the encoder-side device 11) may include the conversion matrices and an inverse of one or more matrices such that audio objects of converted audio received by the decoder device may be reconstructed at the decoder-side device 12, as described herein.

As described thus far, the object number calculator 63 may be configured to determine the number of audio objects 64 from the metadata 15 associated with the received audio objects. In another aspect, the calculator 63 may determine the number based on the audio objects 60. For instance, the calculator may detect how many audio signals are included within the objects 60, and produce the number of objects 64.

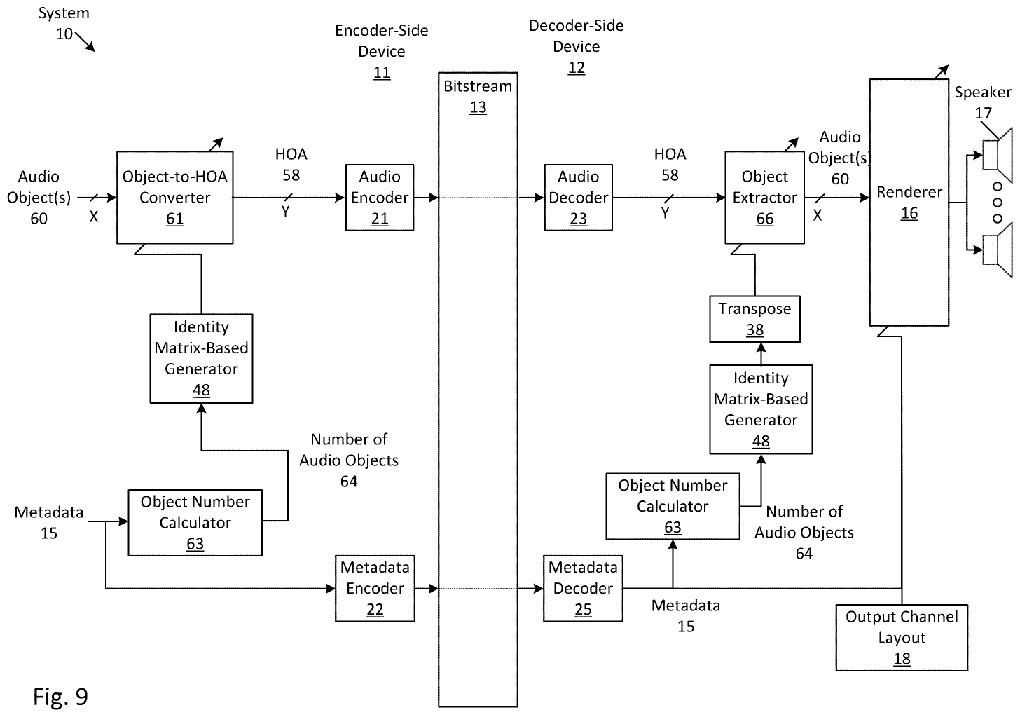

FIG. 9 shows a block diagram of the system 10 for encoding and decoding audio objects using a conversion matrix based on an identity matrix, where the identity matrix may be based on a number of audio objects that are to be transmitted to a decoder-side device via an encoded bitstream according to one aspect. In particular, the encoder-side device 11 includes the identity matrix-based generator 48, which may be configured to generate a conversion matrix based on an identity matrix having an order based on a number of audio objects that are to be encoded and transmitted via the bitstream 13. In particular, the generator 48 receives the number of audio objects 64 calculated by the calculator 63 based on the metadata 15 associated with the audio objects 60, and generates a conversion matrix based on the number. Specifically, the generator 48 determines an identity matrix having an order based on (e.g., equal to) the number of objects 64.

In one aspect, the generator determines whether the order of the identity matrix (or a number of audio objects) is equal to or greater than an order of ambisonics. In particular, the generator may be configured to determine whether the number of audio objects signals to be encoded may be equal to (or greater/lesser than) a number of HOA channels of an order of ambisonics. In one aspect, if the order of the identity matrix is equal to a number of channels associated with an order of ambisonics the generator may set the identity matrix as the conversion matrix. For example, if there are nine audio objects, the generator 48 may set the conversion matrix to be a ninth order identity matrix, since a 2nd order ambisonics includes nine HOA signals.

If, however, the number of objects 64 may be greater (or lesser) than a number of channels of an order of ambisonics, the generator may generate the conversion matrix to have a size based on a number of channels of a next order of ambisonics, which may have more channels than the number of objects. Returning to the previous example, if the number of objects is five objects, the generator may generate an identity matrix of the fifth order (e.g., one main diagonal element of “1” for each audio object), and generate a conversion matrix based on the generated identity matrix. In particular, the generated conversion matrix may have a size that accounts for a 2nd order ambisonics. For example, the conversion matrix may include nine columns, one for each channel of the 2nd order, whereby the conversion matrix may include the generated fifth order identity matrix, having five columns, and four additional columns, making the size of the conversion matrix a 5×9 matrix.

The object-to-HOA converter 61 receives the audio object (signals) 60, having X signals, and converts the signals into a HOA representation 58 based on an identity matrix based on the associated metadata. For example, the identity matrix may be of an order equal to X. The HOA 58 includes several HOA signals, Y that include the audio object signals 60 and one or more additional audio signals such that the total number of signals is equal to Y of an order of ambisonics of HOA 58. For example, the number of additional signals may equal Y X. The additional signals may not include audio data associated with the audio objects 60. As described herein, the audio encoder 21 may be configured to encode, using MP coding-based algorithm, the HOA 58 into the bitstream 13 that may include encoded metadata 15 by the encoder 22.

In one aspect, the object audio signals may be converted to converted audio (e.g., HOA 58) by multiplying an identity matrix-based conversion matrix to the audio signals. If a number of objects, X and a number of converted audio channels, Y, X and Y-X channels of the converted audio are filled with input channels based on the audio object signals and zeros, respectively. The converted audio may be encoded using the MP coding-based algorithm, along with the associated metadata, into the bitstream 13.

The decoder-side 12 includes the identity matrix-based generator 48 and is configured to generate the conversion matrix used by the encoder-side device 11 to convert the audio objects 60 into the converted audio, based on the number of audio objects 64. In particular, the decoder-side device receives the encoded bitstream 13 that includes several HOA channels and metadata 15 associated with several audio objects. Based on the number of audio objects, the generator 48 determines a conversion matrix based on an identity matrix that includes an order that is equal to the number of audio objects. The transpose 38 takes the transpose of the determined conversion matrix, which may be used by the object extractor 66 to convert the decoded HOA 58 (by the audio decoder 23) into the audio objects 60. In particular, the extractor 66 converts HOA channels, Y, of HOA 58 into audio object signals, X, and into one or more additional signals, where the number of signals produced based on the conversion is equal to Y. In which case, when there are additional signals, the extract may discard those signals and send the audio object signals to the renderer 16, where the renderer may receive the metadata 15 and the output channel layout 18 to produce driver signals by rendering the audio signals based on the metadata (and layout). In one aspect, the decoder-side device may use the deriver signals to drive loudspeakers or headphones, which may be coupled to the decoder-side device 12.

In one aspect, based on the received bitstream, the HOA 58 and metadata 15 are decoded. Based on the number of audio objects (and based on the number of HOA channels), a pseudo-inverse of the identity matrix-based conversion matrix used by the encoder-side device 11 is calculated, and used to reconstruct the audio objects by multiplying the HOA 58 by the conversion pseudo-inverse matrix.

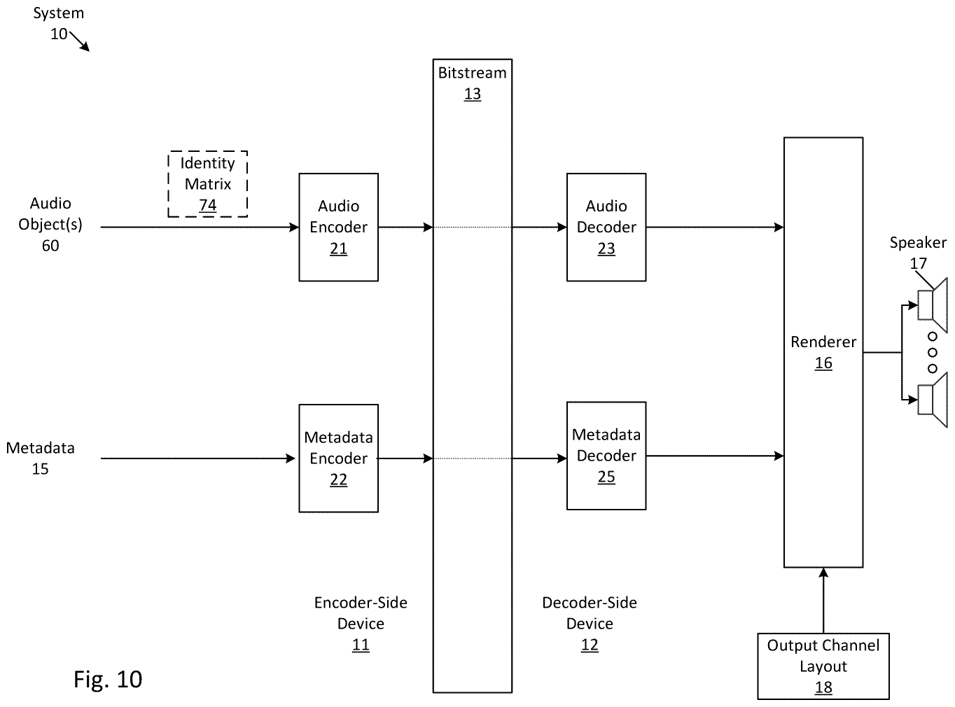

FIG. 10 shows a block diagram of the system 10 for encoding and decoding audio objects according to one aspect. In particular, this figure shows that the received audio objects (e.g., audio signals) 60 and associated metadata are encoded into the bitstream 13 for transmission to the decoder-side device 12. For instance, the audio encoder may encode the audio signals of the audio objects using the MP coding-based algorithm, whereas the metadata encoder 22 may use a metadata coding tool. In one aspect, the encoder-side device may (e.g., optionally) apply an identity matrix 74, which may have an order equal to the number of audio objects by multiplying the audio objects 60 by the identity matrix 74.

On the decoder-side device 12, the encoded audio objects and associated metadata are received through the encoded bitstream 13, and are decoded. The renderer 16 receives the decoded audio objects and associated metadata, and determines a speaker layout of the speakers 17 based on the output channel (speaker) layout 18. For example, the layout may indicate that the speakers 17 are of a headset or are loudspeakers of a surround-sound system. The renderer produces driver signals by rendering the decoder audio objects based on the speaker layout and metadata, and uses the signals to drive the speakers.

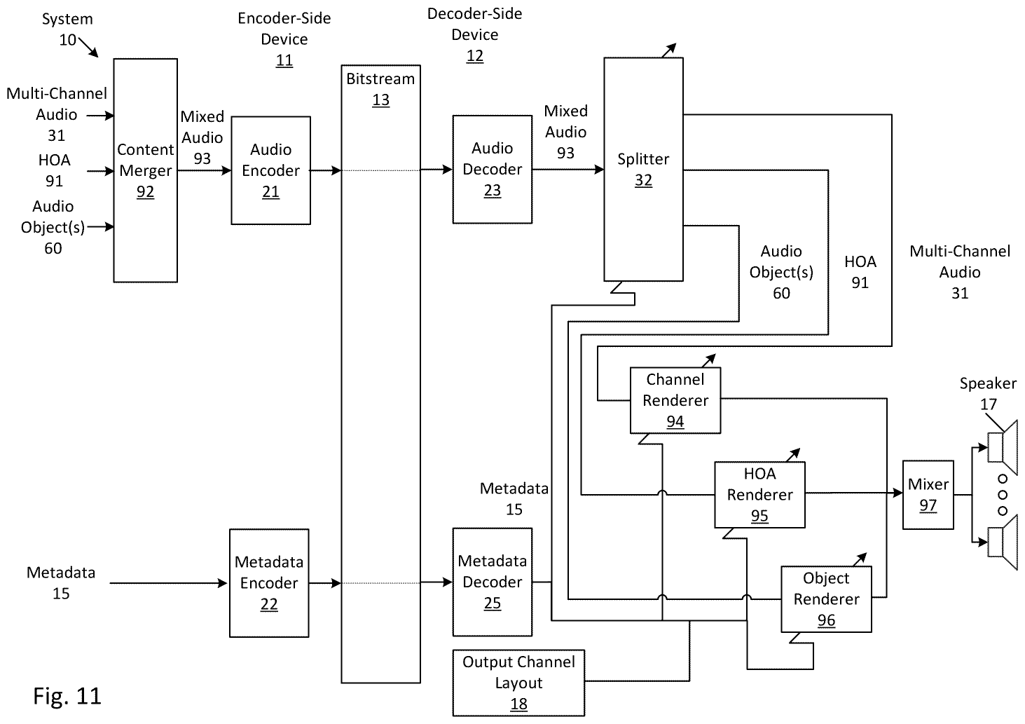

As described thus far, the system 10 may be configured to encode and transmit several types of audio data, such as multi-channel audio and audio objects. In one aspect, the system 10 may be configured to encode and transmit multiple (different or similar) types of audio as mixed audio. FIG. 11 shows a block diagram of such a system according to one aspect. In particular, this figure shows that the encoder-side device 11 includes a content merger 92, the audio encoder 21, and the metadata encoder 22. The encoder-side device 11 may receive multiple types of audio. In particular, it receives (e.g., from an audio source which may be a remote external source, such as an electronic server, and/or may be from local memory of the device 11) the multi-channel audio 31, HOA data 91 (having one or more HOA signals), and/or a set of one or more audio objects 60. In one aspect, the different types of audio may be different audio formats of a same piece of audio content (e.g., a soundtrack of a motion picture). For example, each of the audio formats may include the same sound sources of a piece of audio content. In another aspect, the different types of audio may correspond to different portions (e.g., having different sound sources) of a same piece of audio content, or at least some may be of different pieces of audio content. For example, the multi-channel audio 31 may be a piece of surround-sound audio content (in 5.1 surround-sound format) of the soundtrack of the motion picture, while the HOA data 91 may include a virtual sound space of a virtual environment.

As shown, the encoder-side device 11 is receiving one of each type of audio content. In another aspect, the device may include more or less types and/or more or less similar types of audio content. For example, the encoder-side device 11 may receive the multi-channel audio and the HOA, without the audio objects. As another example, the device may receive multiple types of multi-channel audio. For instance, the multi-channel audio 31 may include a first piece of audio content and a second piece of audio content, both in the same (or differing) surround-sound formats. In addition, the encoder-side device may receive metadata 15 associated with at least some of the pieces of audio content that is being received. In one aspect, the metadata 15 may include channel layout information of the signals that are mixed into the mixed audio. In another aspect, the metadata may include information relating to the specific types of audio, such as having positional data of the audio objects, and other information, such as types of audio processing operations which may be performed by the renderer(s) of the decoder-side device, such as gains, etc.

The content merger 92 may be configured to receive the audio content and merge the content into mixed audio 93. For example, the merger may mix the audio signals of the received audio content into one or more mixed audio signals. In one aspect, the content merger 92 may first convert the received audio content into a same audio format (e.g., converting the HOA data 91 into a surround-sound format), and then may mix the audio signals of the same format to produce the mixed audio. In some aspects, the merger may mix the audio using a mixing matrix. In one aspect, the mixed audio may be a HOA representation of the mixed audio signals (e.g., based on an applied conversion matrix, as described herein).

The audio encoder 21 receives the mixed audio 93 and encodes the mixed audio using the MP coding-based algorithm into the bitstream 13, while the metadata encoder 22 may encode the metadata 15 into the bitstream.

In one aspect, the multi-channel audio, audio objects and HOA signals are merged into one or more mixed audio signals. In one aspect, the resulting mixed audio may be combinations of any heterogenous input audio types, such as channel-based audio and HOA, etc. As described herein, the encoder-side device may receive multi-channel audio for merging and encoding. In another aspect, the device 11 may merge and encode any type of audio. For example, the device may receive one or more audio signals, such as a speech signal, which may not be a part of a multi-channel audio format.

The decoder-side device 12 includes the audio decoder 23, metadata decoder 25, a splitter 32, the output channel layout 18 (which may be stored in memory of the decoder-side device 12), a channel renderer 94, a HOA renderer 95, an object renderer 96, a mixer 97, and speakers 17. In one aspect, although the three renderers are illustrated as being separate blocks, they may be a part of one renderer, such as renderer 16 (which may also include the mixer 97).

The decoder-side device 12 receives the encoded bitstream 13 with the mixed audio and metadata, and the decoders 23 and 25 decode the mixed audio 93 and metadata 15, respectively. The splitter 32 may be configured to receive the mixed audio 93 and split (or extract) one or more different types of audio content. For example, in this case the splitter 32 may extract the audio objects 60, one or more HOA signals 91, and multi-channel audio 31 from the mixed audio 93. In one aspect, the splitter may separate the audio elements based on the received metadata 15. For example, the metadata (e.g., the channel layout information) may indicate which signals of the mixed audio 93 belong to a particular type of audio content, or it may indicate which portions of the mixed audio 93 may be associated with the types of audio content.

The decoder-side device 12 produces, based on the metadata 15 and/or the output channel layout 18 (which may indicate the layout and number of speakers 17), a first set of one or more driver signals by rendering the multi-channel audio 31, 2) a second set of one or more driver signals by rendering the HOA 91, and/or 3) a third set of one or more driver signals by rendering the audio objects 60. In particular, the channel renderer 94 may receive the multi-channel audio 31 and render the multi-channel audio signals to the speakers 17 based on the layout 18, the HOA renderer 95 may render the HOA 91 signals according to the layout of the speakers, and the object renderer 96 may render the audio objects 60 using the metadata15, which may indicate positional data of sound sources within a sound field of the audio objects, and the layout 18 (in order to properly place the audio objects within a sound field of the speakers. In one aspect, each of the renderers may produce a driver signal for each speaker 17.

The mixer 97 receives the rendered audio signals from each (or at least one of) the renderers and produces a mixed set of one or more driver signals by mixing the rendered (corresponding) driver signals together. The decoder-side device 12 uses the mixed driver signals to drive the speakers 17. In one aspect, one or more spatial filters (e.g., HRTFs) may be applied to the mixed signals in order to produce spatially rendered audio, such as binaural audio that may be used to drive speakers of headphones.

In one aspect, based on the received bitstream 13, mixed audio signals and metadata (which may include input audio channel layout information) are decoded (e.g., the mixed audio signals may be decided using MP coding-based algorithm. Based on the decoded metadata, the mixed audio signals may be split into the original input types, e.g., channel, object, and HOA signals. Based on the decoded metadata, the decoder-side device 12 may render the original input types (which are reconstructed by the decoder-side device), e.g., channel, object, and HOA signals based on the output signal.

As described herein, the encoder-side device 11 and the decoder-side device 12 may perform one or more operations of one or more operational blocks. In particular, the devices perform the operations by one or more electronic components of the respective devices, such as one or more processors, performing the operations of the operational blocks described herein.

In one aspect, operations described herein, which may be performed by the encoder-side device 11 and/or the decoder-side device 12, may be implemented in software (e.g., as instructions stored in memory and executed by one or more processors of either or both devices) and/or may be implemented by hardware logic structures of the devices as described herein.

In another aspect, at least some of the operations performed by the system 10 as described herein may be performed by the encoder-side device 11 and/or by the decoder-side device 12. For instance, the encoder-side device may include two or more speakers and may be configured to perform decoder-side operations to render audio content received through one or more bitstreams. In another aspect, at least some of the operations may be performed by a remote server that is communicatively coupled with either device, for example over the network (e.g., Internet).

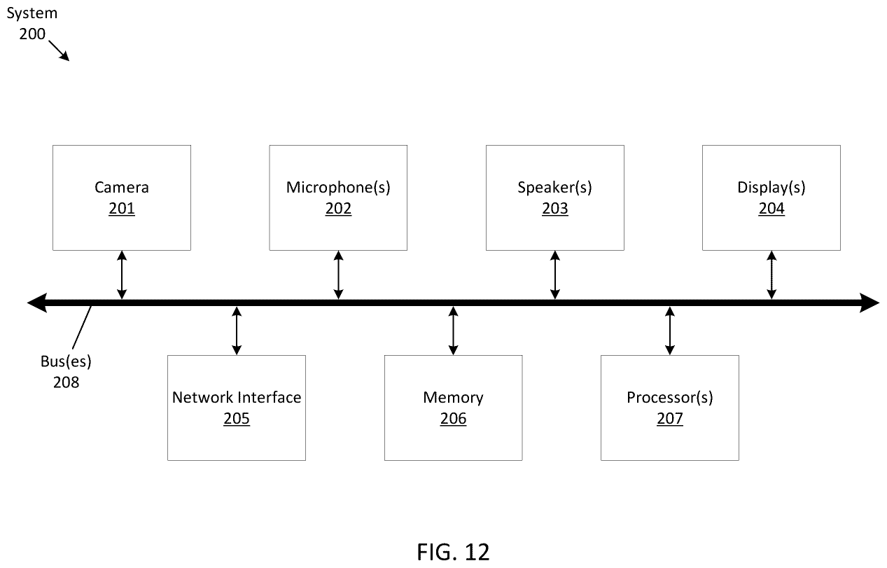

FIG. 12 shows a block diagram of audio processing system hardware, in one aspect, which may be used with any of the aspects described herein, e.g., with the encoder-side device 11 and/or with the decoder-side (or audio playback) device 12. This audio processing system can represent a general-purpose computer system or a special purpose computer system. Note that while FIG. 12 illustrates the various components of an audio processing system that may be incorporated into one or more of the devices described herein, it is merely one example of a particular implementation and is merely to illustrate the types of components that may be present in the system. FIG. 12 is not intended to represent any particular architecture or manner of interconnecting the components as such details are not germane to the aspects herein. It will also be appreciated that other types of audio processing systems that have fewer components than shown or more components than shown in FIG. 12 can also be used. Accordingly, the processes described herein are not limited to use with the hardware and software of FIG. 12.

As shown in FIG. 12, the audio processing system (or system) 200 (for example, a laptop computer, a desktop computer, a mobile phone, a smart phone, a tablet computer, a smart speaker, a head mounted display (HMD), a headphone (headset), or an infotainment system for an automobile or other vehicle) includes one or more buses 208 that serve to interconnect the various components of the system. One or more processors 207 are coupled to bus 208 as is known in the art. The processor(s) may be microprocessors or special purpose processors, system on chip (SOC), a central processing unit, a graphics processing unit, a processor created through an Application Specific Integrated Circuit (ASIC), or combinations thereof. Memory 206 can include Read Only Memory (ROM), volatile memory, and non-volatile memory, or combinations thereof, coupled to the bus using techniques known in the art. Camera 201, microphone(s) 202, speaker(s) 203, and display(s) 204 may be coupled to the bus.

Memory 206 can be connected to the bus and can include DRAM, a hard disk drive or a flash memory or a magnetic optical drive or magnetic memory or an optical drive or other types of memory systems that maintain data even after power is removed from the system. In one aspect, the processor 207 retrieves computer program instructions stored in a machine-readable storage medium (memory) and executes those instructions to perform operations described herein.

Audio hardware, although not shown, can be coupled to the one or more buses 208 in order to receive audio signals to be processed and output (or played back) by speakers 203. Audio hardware can include digital to analog and/or analog to digital converters. Audio hardware can also include audio amplifiers and filters. The audio hardware can also interface with microphones 202 (e.g., microphone arrays) to receive audio signals (whether analog or digital), digitize them if necessary, and communicate the signals to the bus 208.

The network interface 205 may communicate with one or more remote devices and networks. For example, interface can communicate over known technologies such as Wi-Fi, 3G, 4G, 5G, Bluetooth, ZigBee, or other equivalent technologies. The interface can include wired or wireless transmitters and receivers that can communicate (e.g., receive and transmit data) with networked devices such as servers (e.g., the cloud) and/or other devices such as remote speakers and remote microphones.

It will be appreciated that the aspects disclosed herein can utilize memory that is remote from the system, such as a network storage device which is coupled to the audio processing system through a network interface such as a modem or Ethernet interface. The buses 208 can be connected to each other through various bridges, controllers and/or adapters as is well known in the art. In one aspect, one or more network device(s) can be coupled to the bus 208. The network device(s) can be wired network devices (e.g., Ethernet) or wireless network devices (e.g., WI-FI, Bluetooth). In some aspects, various aspects described (e.g., determination, estimation, analysis, modeling, etc.,) can be performed by a networked server in communication with the capture device.

Various aspects described herein may be embodied, at least in part, in software. That is, the techniques may be carried out in an audio processing system in response to its processor executing a sequence of instructions contained in a storage medium, such as a non-transitory machine-readable storage medium (e.g., DRAM or flash memory). In various aspects, hardwired circuitry may be used in combination with software instructions to implement the techniques described herein. Thus, the techniques are not limited to any specific combination of hardware circuitry and software, or to any particular source for the instructions executed by the audio processing system.

In the description, certain terminology is used to describe features of various aspects. For example, in certain situations, the terms “transform”, “renderer”, “layout”, “splitter”, “controller”, “component,” “unit,” “module,” “logic”, “extractor”, “converter”, “model” “merger”, “codebook” “filter”, “generator”, “calculator”, “processor”, “mixer”, “matrix”, “transpose”, “encoder” and “decoder” are representative of hardware and/or software configured to perform one or more processes or functions. For instance, examples of “hardware” include, but are not limited or restricted to an integrated circuit such as a processor (e.g., a digital signal processor, microprocessor, application specific integrated circuit, a micro-controller, etc.). Thus, different combinations of hardware and/or software can be implemented to perform the processes or functions described by the above terms, as understood by one skilled in the art. Of course, the hardware may be alternatively implemented as a finite state machine or even combinatorial logic. An example of “software” includes executable code in the form of an application, an applet, a routine or even a series of instructions. As mentioned above, the software may be stored in any type of machine-readable medium.

According to another aspect of the disclosure, a method performed by an encoder-side device for encoding audio data, the method including: receiving audio content in a surround-sound format that includes metadata based on the surround-sound format, the audio content includes a group of surround-sound channels that includes a group of full-range audio channels and a low-frequency effects (LFE) channel; splitting the group of surround-sound channels into the group of full-range audio channels and the LFE channel; converting the full-range audio channels into a higher-order ambisonics (HOA) representation using a spherical harmonics (SPH) matrix that is based on the metadata; encoding, using a Matching Pursuit (MP) coding-based algorithm, the HOA representation; and transmitting the encoded HOA representation, the LFE channel, and the metadata as at least one bitstream to a decoder-side device. In one aspect, the method further includes encoding the LFE channel separately from the group of full-range audio channels, the encoded LFE channel is included within the at least one bitstream.

According to another aspect of the disclosure, a method performed by a decoder-side device for decoding audio data, the method including: receiving an encoded bitstream that includes a higher-order ambisonics (HOA) signal, a low-frequency effects (LFE) channel, and associated metadata; producing a decoded HOA signal using a Matching Pursuit (MP) coding-based algorithm; converting the decoded HOA signal into a group of full-range audio channels using a spherical harmonics (SPH) matrix that is based on the metadata; merging the LFE channel and the group of full-range audio channels into a group of surround-sound channels in a surround-sound format based on the metadata; and driving a group of speakers using the surround-sound channels according to the surround-sound format.

According to another aspect of the disclosure, a method performed by an encoder-side device for encoding audio data, the method including: receiving audio content in a surround-sound format that includes metadata based on the surround-sound format, where the audio content includes a group of surround-sound audio channels; splitting the group of surround-sound audio channels into a group of full-range audio channels and at least one low-frequency effects (LFE) channel based on the metadata; retrieving, from a codebook stored in memory of the encoder-side device, a conversion matrix based on the metadata; converting the group of full-range audio channels into a higher-order ambisonics (HOA) representation using the conversion matrix; and encoding, using a Matching Pursuit (MP) coding-based algorithm, the HOA representation into a bitstream for transmission to a decoder-side device.

According to another aspect of the disclosure, a method performed by a decoder-side device for decoding audio data, the method including: receiving a group of higher-order ambisonics (HOA) signals, a low-frequency effects (LFE) channel, and metadata as an encoded bitstream; extracting the group of HOA signals, the LFE channel, and the metadata from the encoded bitstream, where the group of HOA signals are extracted by using a Matching Pursuit (MP) coding-based algorithm; retrieving, from a codebook stored in memory of the decoder-side device, an HOA-to-Channel conversion matrix based on the metadata; producing a group of full-range audio channels by applying the HOA-to-Channel conversion matrix to the extracted group of HOA signals; and producing multi-channel audio by merging the group of full-range audio channels with the LFE channel.

According to another aspect of the disclosure, a method performed by an encoder-side device for encoding audio data, the method including: receiving audio content in a surround-sound format that includes metadata based on the surround-sound format; separating, from the audio content, a group of audio channels and a low-frequency effects (LFE) channel based on the metadata; converting the group of audio channels into converted audio based on an identity matrix based on the metadata, where the converted audio includes a group of channels that include the group of audio channels and one or more additional channels such that a total number of channels is equal to an order of ambisonics, where the one or more additional channels do not include the audio content; and encoding, using a Matching Pursuit (MP) coding-based algorithm, the converted audio into the bitstream.

According to another aspect of the disclosure, a method performed by a decoder-side device for decoding audio data, the method including: receiving, as an encoded bitstream, audio content a low-frequency effects (LFE) channel of a piece of surround-sound audio content, and metadata associated with the audio content and the LFE channel, where the audio content includes a group of channels that were generated by applying a conversion matrix that is based on an identity matrix based on the metadata to a group of non-LFE surround-sound channels of the piece of surround-sound audio content, where the group of channels includes the group of non-LFE surround-sound channels and at least one additional channel that does not include audio data; producing a transpose of the conversion matrix; reconstructing the group of non-LFE surround-sound channels and the at least one additional channel by applying the transpose of the conversion matrix to the audio content; and using the group of non-LFE surround-sound channels and the LFE channel to drive a group of speakers.

According to another aspect of the disclosure, a method performed by an encoder-side device for encoding audio data, the method including: receiving audio content in a surround-sound format that includes metadata based on the surround-sound format; separating, from the audio content, a group of surround-sound audio channels and a low-frequency effects (LFE) channel based on the metadata; encoding, using a Matching Pursuit (MP) coding-based algorithm, the group of surround-sound audio channels; encoding the LFE channel and the metadata; and transmitting the encoded group of surround-sound audio channels, LFE channel, and metadata as a bitstream to a decoder-side device.

According to another aspect of the disclosure, a method performed by a decoder-side device for decoding audio data, the method including: receiving an encoded bitstream that includes a group of surround-sound channels, a low-frequency effects (LFE) channel, and metadata; extracting the channels and the metadata by performing one or more decoding algorithms that includes a Matching Pursuit (MP) coding-based algorithm; based on the metadata, producing a surround-sound format that includes the group of surround-sound channels and the LFE channel.

According to another aspect of the disclosure, a method performed by an encoder-side device for encoding audio data, the method including: receiving a set of one or more audio objects, each audio object having an audio signal and associated metadata; determining, based on the associated metadata, a number of audio objects in the set; determining, based on the number of audio objects in the set, a conversion matrix from a conversion matrix codebook, where the conversion matrix is for 1) mapping each audio signal of the set to a surround-sound speaker position of a group of surround-sound speaker positions and 2) converting the set of one or more audio objects to a higher-order ambisonics (HOA) representation according to the group of surround-sound speaker positions, where a number of speaker positions of the conversion matrix is greater than or equal to a number of audio signals of the set; producing the HOA representation of the set by applying the conversion matrix to the set of one or more audio objects; and encoding, using a Matching Pursuit (MP) coding-based algorithm, the HOA representation into a bitstream that includes the associated metadata.

According to another aspect of the disclosure, a method performed by a decoder-side device for decoding audio data, the method including: receiving an encoded bitstream that includes 1) a higher-order ambisonics (HOA) representation of audio content and 2) metadata associated with the audio content; determining, based on the metadata, a number of audio objects of the audio content; determining, based on the number of audio objects, a conversion matrix from a conversion matrix codebook, where the conversion matrix is for 1) converting the HOA representation into the group of surround-sound audio channels and 2) reconstructing the one or more audio objects from the group of surround-sound audio channels; producing the one or more audio objects from the HOA representation using the conversion matrix; and spatially rendering loudspeaker or headphone driver signals using the one or more audio objects and the metadata.

According to another aspect of the disclosure, a method performed by an encoder-side device for encoding audio data, the method including: generating a group of spherical projection grids, each spherical projection grid having a different number of speaker locations on a surface of the spherical projection grid according to a spherical T-design; generating and storing in a codebook, for each spherical projection grid of the group of spherical projection grids, a conversion matrix for converting one or more audio objects to higher-order ambisonics (HOA) using spherical harmonics of a respective number of speaker locations; receiving a set of one or more audio objects, each audio object having an audio signal and associated metadata; determining, based on the associated metadata, a number of audio objects in the set; retrieving, based on the number of audio objects and from the codebook, a particular conversion matrix associated with a number of speaker locations that is greater than or equal to the number of audio objects in the set; producing a HOA representation of the set by applying the set of one or more audio signals to the particular conversion matrix; and encoding, using a Matching Pursuit (MP) coding-based algorithm, the HOA representation into a bitstream that includes the associated metadata.

According to another aspect of the disclosure, a method performed by a decoder-side device for decoding audio data, the method including: receiving a bitstream that includes an encoded higher-order ambisonics (HOA) data and encoded audio object metadata for a set of one or more audio objects; decoding the encoded HOA data using a Matching Pursuit (MP) coding-based algorithm; determining, using the audio object metadata from the bitstream, a number of audio objects of the set; selecting, from a conversion matrix codebook that includes a group of conversion matrices that is each for converting HOA data to a different number of audio objects; producing the set of one or more audio objects that are reconstructed from the decoded HOA data by applying the selected conversion matrix to the decoded HOA data; and spatially rendering loudspeaker or headphone driver signals using the one or more audio objects and the metadata.

According to another aspect of the disclosure, a method performed by an encoder-side device for encoding audio data, the method including: generating a group of spherical projection grids, each spherical projection grid having a different number of speaker locations on a surface of the spherical projection grid according to a Fliege-Maier set; generating and storing in a codebook, for each spherical projection grid of the group of spherical projection grids, a conversion matrix for converting one or more audio objects to higher-order ambisonics (HOA) using spherical harmonics of a respective number of speaker locations; receiving a set of one or more audio objects, each audio object having an audio signal and associated metadata; determining, based on the associated metadata, a number of audio objects in the set; retrieving, based on the number of audio objects and from the codebook, a particular conversion matrix associated with a number of speaker locations that is greater than or equal to the number of audio objects in the set; producing a HOA representation of the set by applying each audio signal of the set to the particular conversion matrix; and encoding, using a Matching Pursuit (MP) coding-based algorithm, the HOA representation into a bitstream that includes the associated metadata.

According to another aspect of the disclosure, a method performed by an encoder-side device for encoding audio data, the method including: receiving a group of audio object signals of a group of audio objects and associated metadata; determining, based on the associated metadata, a number of audio objects in the group; converting the group of audio object signals into a HOA representation based on an identity matrix that is based on the associated metadata, where the HOA representation includes a group of HOA signals that include the group of audio object signals and one or more additional audio signals such that a total number of audio signals is equal to a number of HOA signals of an order of ambisonics of the HOA representation, where the one or more additional audio signals do not include audio data of the group of audio objects; and encoding, using a Matching Pursuit (MP) coding-based algorithm, the HOA representation into a bitstream that includes the associated metadata.

According to another aspect of the disclosure, a method performed by a decoder-side device for decoding audio data, the method including: receiving an encoded bitstream that includes 1) a group of higher-order ambisonics (HOA) channels and 2) metadata associated with a group of audio objects; determining, based on the metadata, a number of audio objects in the group; determining, based on the number of audio objects, a conversion matrix based on an identity matrix that includes an order that is equal to the number of audio objects; converting the group of HOA channels into a group of audio signals of the group of audio objects and one or more additional audio signals, where a number of audio signals based on the conversion is equal to a number of HOA channels in the group; producing a group of driver signals by rendering the group of audio signals based on the metadata; and using the group of driver signals to drive a group of loudspeakers or a group of speakers of a headset.

In one aspect, a size of the conversion matrix is based on a number of HOA channels in the group.

According to another aspect of the disclosure, a method performed by an encoder-side device for encoding audio data, the method including: receiving a set of one or more audio objects, each audio object including an audio signal and associated metadata; encoding, using a Matching Pursuit (MP) coding-based algorithm, each audio signal of the set of one or more audio objects; and transmitting the encoded audio signals along with the associated metadata as a bitstream to a decoder-side device.

According to another aspect of the disclosure, a method performed by a decoder-side device for decoding audio data, the method including: receiving an encoded bitstream that includes a group of audio signals for a group of audio objects and associated metadata; decoding, using a Matching Pursuit (MP) coding-based algorithm, the group of audio signals; determining a speaker layout of a group of speakers of the decoder-side device; and producing a group of driver signals by rendering the group of audio signals based on the speaker layout and the metadata; and using the group of driver signals to drive the group of speakers.

According to another aspect of the disclosure, a method performed by an encoder-side device for encoding audio data, the method including: receiving: a group of audio signals in a surround-sound format, a set of one or more audio objects, each audio object including an audio signal, a higher-order ambisonics (HOA) representation of a sound field that includes a group of HOA signals, and metadata associated with at least some of the received signals; merging the received signals into mixed audio; encoding the mixed audio using a Matching Pursuit (MP) coding-based algorithm; and transmitting the encoded mixed audio in a bitstream that includes the metadata to a decoder-side device.

According to another aspect of the disclosure, a method performed by a decoder-side device for decoding audio data, the method including: receiving a bitstream that includes an encoded audio mix and metadata associated with the encoded audio mix; producing a decoded audio mix by decoding the encoded audio mix using a Matching Pursuit (MP) coding-based algorithm; extracting, from the decoded audio mix, one or more surround sound audio channels, the one or more audio objects, and the one or more HOA signals; producing, based on the metadata and an output channel layout of one or more speakers, 1) a first set of one or more driver signals by rendering the one or more surround sound audio channels, 2) a second set of one or more driver signals by rendering the one or more audio objects, and 3) a third set of one or more driver signals by rendering the one or more HOA signals; producing a mixed set of one or more driver signals by mixing the first, second, and third sets together; and using the mixed set of one or more driver signals to drive the one or more speakers of the decoder-side device.

In one aspect, the encoded input audio signal and the metadata may be transmitted by the encoder-side to the decoder-side in the same audio bitstream, or in different audio bitstreams (e.g., at different times). In another aspect, the metadata includes speaker layout information associated with surround-sound audio channels and positional information relating to a set of one or more audio objects. In another aspect, converting the first set of non-LFE channels into a HOA representation includes determining a conversion matrix based on a surround-sound speaker layout information of the non-LFE channels; and producing the HOA representation by applying the conversion matrix upon the first set. In another aspect, an identify matrix based on a number of the non-LFE channels, where converting comprises applying the identity matrix upon the non-LFE channels.

Some portions of the preceding detailed descriptions have been presented in terms of algorithms and symbolic representations of operations on data bits within a computer memory. These algorithmic descriptions and representations are the ways used by those skilled in the audio processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of an audio processing system, or similar electronic device, that manipulates and transforms data represented as physical (electronic) quantities within the system's registers and memories into other data similarly represented as physical quantities within the system memories or registers or other such information storage, transmission or display devices.

The processes and blocks described herein are not limited to the specific examples described and are not limited to the specific orders used as examples herein. Rather, any of the processing blocks may be re-ordered, combined, or removed, performed in parallel or in serial, as necessary, to achieve the results set forth above. The processing blocks associated with implementing the audio processing system may be performed by one or more programmable processors executing one or more computer programs stored on a non-transitory computer readable storage medium to perform the functions of the system. All or part of the audio processing system may be implemented as special purpose logic circuitry (e.g., an FPGA (field-programmable gate array) and/or an ASIC (application-specific integrated circuit)). All or part of the audio system may be implemented using electronic hardware circuitry that include electronic devices such as, for example, at least one of a processor, a memory, a programmable logic device or a logic gate. Further, processes can be implemented in any combination hardware devices and software components.

As previously explained, an aspect of the disclosure may be a non-transitory machine-readable medium (such as microelectronic memory) having stored thereon instructions, which program one or more data processing components (generically referred to here as a “processor”) to perform coding (e.g., encoding and/or decoding) of audio data (content), digital signal processing operations, audio (spatial) rendering operations, network operations, and audio signal processing operations, as described herein. In other aspects, some of these operations might be performed by specific hardware components that contain hardwired logic. Those operations might alternatively be performed by any combination of programmed data processing components and fixed hardwired circuit components.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A decoder-side method, the method comprising:
receiving a bitstream that includes an encoded representation of an input audio signal and metadata associated with the input audio signal;
producing a decoded representation of the input audio signal by decoding the encoded representation using a Matching Pursuit (MP) coding-based algorithm;
producing a plurality of audio driver signals by rendering the input audio signal based on the metadata; and
driving a plurality of speakers using the plurality of audio driver signals.

2. The method of claim 1, wherein the decoded representation comprises a higher-order ambisonics (HOA) representation of the input audio signal, wherein the method further comprising applying a conversion matrix to the HOA representation to reconstruct the input audio signal.

3. The method of claim 2, wherein the input audio signal comprises a plurality of full-range audio channels of a surround-sound format, wherein the method further comprises receiving at least one band-limited audio channel associated with the surround-sound format, wherein producing the plurality of audio driver signals comprises assigning each of the channels to a particular speaker of the plurality of speakers based on the metadata.

4. The method of claim 2, wherein the input audio signal comprises a set of one or more audio objects and the metadata comprises positional information relating to the set of one or more audio objects, wherein the plurality of audio driver signals are produced by spatially rendering the set of one or more audio objects according to the positional information.

5. The method of claim 4 further comprising:
determining a number of the set of one or more audio objects; and
determining the conversion matrix based on the number.

6. The method of claim 4 further comprising receiving an output speaker layout for the plurality of speakers, wherein the set of one or more audio objects are spatially rendered according to the output speaker layout.

7. The method of claim 2, wherein the bitstream is received from an encoder-side device, wherein the conversion matrix is an inverse matrix of a matrix used by the encoder-side device to produce the encoded representation of the input audio signal.

8. The method of claim 1, wherein the decoded representation of the input audio signal comprises a mixed signal, wherein the method further comprises, splitting the mixed signal into:
a plurality of surround-sound channels of a surround-sound format,
one or more audio objects that include one or more audio signals, and
HOA data that includes a plurality of HOA signals.

9. The method of claim 8, wherein producing the plurality of audio driver signals comprises:
rendering the plurality of surround-sound channels, the one or more audio signals, and the plurality of HOA signals according to the metadata and an output speaker layout of the plurality of speakers; and
mixing the renderings into the plurality of audio driver signals.

10. A decoder-side device comprising:
at least one processor; and
memory having stored instructions which when executed by the at least one processor causes the decoder-side device to:
receive a bitstream that includes an encoded representation of an input audio signal and encoded metadata associated with the input audio signal;
produce a decoded representation of the input audio signal by decoding the encoded representation using a Matching Pursuit (MP) coding-based algorithm;
produce a plurality of audio driver signals based on the decoded representation of input audio signal and the metadata; and
drive a plurality of speakers using the plurality of audio driver signals.

11. The decoder-side device of claim 10, wherein the decoded representation comprises a higher-order ambisonics (HOA) representation of the input audio signal, wherein the memory has further instructions to apply a conversion matrix to the HOA representation to reconstruct the input audio signal, wherein the plurality of audio driver signals are produced by rendering the input audio signal based on the metadata.

12. The decoder-side device of claim 11, wherein the input audio signal comprises a plurality of full-range audio channels of a surround-sound format, wherein the memory has further instructions to receive at least one band-limited audio channel associated with the surround-sound format, wherein the instructions to produce the plurality of audio driver signals comprises instructions to assign each of the channels to a particular speaker of the plurality of speakers based on the metadata.

13. The decoder-side device of claim 11, wherein the input audio signal comprises a set of one or more audio objects and the metadata comprises positional information relating to the set of one or more audio objects, wherein the plurality of audio driver signals are produced by spatially rendering the set of one or more audio objects according to the positional information and a layout of the plurality of speakers.

14. The decoder-side device of claim 11, wherein the bitstream is received from an encoder-side device, wherein the conversion matrix is an inverse matrix of a matrix used by the encoder-side device to produce the encoded representation of the input audio signal.

15. The decoder-side device of claim 10, wherein the decoded representation of the input audio signal comprises a mixed signal, wherein the memory has further instructions to split the mixed signal into:
a plurality of surround-sound channels of a surround-sound format,
one or more audio objects that include one or more audio signals, and
HOA data that includes a plurality of HOA signals.

16. The decoder-side device of claim 15, wherein the instructions to produce the plurality of audio driver signals comprises instructions to:
render the plurality of surround-sound channels, the one or more audio signals, and the plurality of HOA signals according to the metadata and an output speaker layout of the plurality of speakers; and
mix the renderings into the plurality of audio driver signals.

17. An encoder-side method, the method comprising:
receiving an input audio signal of a piece of audio content and metadata relating to the input audio signal;
encoding, using a Matching Pursuit (MP) coding-based algorithm, the input audio signal; and
transmitting the encoded input audio signal and the metadata to an audio playback device.

18. The method of claim 17, wherein the input audio signal comprises a plurality of surround-sound audio channels that includes a sound source, wherein the plurality of surround-sound audio channels comprises a first set of one or more full-range audio channels and a second set of one or more band-limited audio channels, wherein the method further comprises converting the first set into a higher-order ambisonics (HOA) representation of the sound source, wherein encoding comprises encoding, using the MP coding-based algorithm, the HOA representation into a bitstream for transmission to the audio playback device.

19. The method of claim 18 further comprising encoding the second set into the bitstream separately from the encoded HOA representation.

20. The method of claim 18, wherein the metadata comprises surround-sound speaker layout information for the plurality of surround-sound audio channels, wherein the first set is converted into HOA representation according to the surround-sound speaker layout information.

21. The method of claim 17,
wherein receiving an input audio signal comprises receiving a set of one or more audio objects, each audio object having at least one audio signal,
wherein the method further comprises producing a higher-order ambisonics (HOA) representation of the set of one or more audio objects,
wherein encoding comprises encoding, using the MP coding-based algorithm, the HOA representation into a bitstream for transmission to the audio playback device.

22. The method of claim 21 further comprising:
determining a number of the set of one or more audio objects; and
determining a conversion matrix based on the number,
wherein the HOA representation is produced by applying the conversion matrix to the set of one or more audio objects.

23. The method of claim 17,
wherein the input audio signal comprises: a plurality of surround-sound audio channels of the piece of audio content, a higher-order ambisonics (HOA) representation of the piece of audio content and a set of one or more audio objects of the piece of audio content,
wherein the method further comprises producing a mixed audio signal that includes the plurality of surround-sound audio channels, the HOA representation, and the set of one or more audio objects, wherein encoding comprises encoding, using the MP coding-based algorithm, the mixed audio signal into a bitstream for transmission to the audio playback device.
